(19) United States
(12) Patent Application Publication
(10) Pub. No.: US 2023/0179778 A1
(43) Pub. Date: Jun. 8, 2023

(54) INFORMATION PROCESSING APPARATUS, INFORMATION PROCESSING METHOD, AND PROGRAM

(71) Applicant: SONY GROUP CORPORATION, TOKYO (JP)

(72) Inventors: YUYA YAMASHITA, TOKYO (JP); HIRONORI HATTORI, TOKYO (JP); KAZUMASA TANAKA, TOKYO (JP); YUTA MATSUI, TOKYO (JP); SHIGERU OHWADA, TOKYO (JP)

(21) Appl. No.: 17/998,932

(22) PCT Filed: May 21, 2021
(86) PCT No.: PCT/JP2021/019328

§ 371 Date: Nov. 16, 2022

(30) Foreign Application Priority Data
May 28, 2020 (JP) 2020-093052

(51) Int. Cl. H04N 19/179; H04N 19/142; H04N 5/93; G06F 16/783

(52) U.S. Cl. CPC H04N 19/179; H04N 19/142; H04N 5/93; G06F 16/783

(57) ABSTRACT

An information processing apparatus includes a control unit that performs first control processing of deciding an analysis engine for scene detection from among a plurality of analysis engines on the basis of scene detection information for scene detection with respect to an input video, and second control processing of deciding an analysis engine for obtaining second result information related to the scene from among a plurality of analysis engines, on the basis of scene-related information regarding a scene obtained as first result information by the analysis engine decided in the first control processing.

### TECHNICAL FIELD

The present technology relates to an information processing apparatus, an information processing method, and a program, and particularly relates to technology for analyzing moving image data using an analysis engine.

### BACKGROUND ART

A technique for analyzing moving image data by using an analysis engine has been proposed. For example, Patent Document 1 below discloses a technique for deciding an analysis engine from among a plurality of analysis engines according to content of an analysis processing request and using the analysis engine for analysis processing.

### CITATION LIST

### Patent Document

Patent Document 1: WO 2012/108125

### SUMMARY OF THE INVENTION

### Problems to be Solved by the Invention

By the way, for example, in creation of a highlight video that is a collection of important scenes, or the like, it is not sufficient to simply identify an important scene, and it is important to appropriately set a clipping range before and after the identified scene.

The present technology has been made in view of such circumstances, and an object thereof is to appropriately identify a scene and a clipping range by using an analysis engine.

### Solutions to Problems

An information processing apparatus according to the present technology includes a control unit that performs first control processing of deciding an analysis engine for scene detection from among a plurality of analysis engines on the basis of scene detection information for scene detection with respect to an input video, and second control processing of deciding an analysis engine for obtaining second result information related to the scene from among a plurality of analysis engines, on the basis of scene-related information regarding a scene obtained as first result information by the analysis engine decided in the first control processing.

The input video is assumed to be, for example, content produced on the basis of images of a certain sport captured by one or a plurality of cameras, or the like. Furthermore, there is assumed a system having a plurality of analysis engines for analyzing such a video. In such a system, an information processing apparatus including a function as a control unit decides, in first control processing, one or a plurality of analysis engines for detecting a predetermined scene as first result information in the video, and decides, in second control processing, one or a plurality of analysis engines for identifying second result information related to the scene.

In the above-described information processing apparatus, the second result information may include time information related to the scene obtained as the first result information. That is, in the second control processing, an analysis engine for obtaining the second result information including at least time information regarding the scene is decided.

In the above-described information processing apparatus, the second result information may include scene start information related to a start of the scene obtained as the first result information and scene end information related to an end of the scene obtained as the first result information, and, in the second control processing, an analysis engine for identifying the scene start information and an analysis engine for identifying the scene end information may be decided.

That is, in the second control processing, analysis engines for obtaining the second result information including scene start information and scene end information are decided as the second result information, in which analysis engines corresponding to the scene start information and to the scene end information are decided separately.

In the above-described information processing apparatus, the scene-related information may include scene-type information, and, in the second control processing, an analysis engine for obtaining second result information may be decided on the basis of the scene-type information.

That is, in the second control processing, an analysis engine for obtaining the second result information is decided, in which a corresponding analysis engine is decided according to a type of a target scene.

In the above-described information processing apparatus, the second result information may include scene start information related to a start of the scene obtained as the first result information and scene end information related to an end of the scene obtained as the first result information, and, in the second control processing, an analysis engine for identifying the scene start information and an analysis engine for identifying the scene end information may be decided according to a type of the scene obtained as the first result information.

That is, in the second control processing, analysis engines for obtaining the second result information including scene start information and scene end information are decided as the second result information, in which an analysis engine for obtaining the scene start information and an analysis engine for obtaining the scene end information are decided according to a scene type.

In the above-described information processing apparatus, the second result information may include time information related to the scene obtained as the first result information, and the control unit may perform third control processing of deciding, from among a plurality of analysis engines, an analysis engine for obtaining third result information obtained by analyzing a section identified in a video with the time information.

In a case where a section in the video is identified for a certain scene as the second result information, an analysis engine for performing detailed analysis of the section is decided.

In the above-described information processing apparatus, in the third control processing, an analysis engine for obtaining third result information may be decided on the basis of scene-type information.

That is, in the third control processing, an analysis engine for obtaining the third result information is decided, in which a corresponding analysis engine is decided according to a type of a target scene.

In the above-described information processing apparatus, the scene-related information may be managed in association with the scene detection information, and the scene-related information may be set corresponding to a setting of the scene detection information.

The management is performed such that the scene-related information is identified in response to identification of the scene detection information for scene detection.

In the above-described information processing apparatus, the control unit may set the scene detection information corresponding to input of a scene type.

For example, the scene detection information is set according to a scene type input according to a user operation, automatic determination, or the like.

In the above-described information processing apparatus, the control unit may set the scene detection information corresponding to input of a sport type.

For example, the scene detection information is set according to a sport type (for example, a sport type of sports, or the like) input according to a user operation, automatic determination, or the like.

In the above-described information processing apparatus, the control unit may generate metadata based on the first result information and the second result information, and may perform processing of linking the generated metadata to the input video. For example, information such as detected scene information and time information thereof are generated as metadata and used as information related to the input video.

In the above-described information processing apparatus, the control unit may generate metadata based on the first result information, the second result information, and the third result information, and may perform processing of linking the generated metadata to the input video.

For example, information such as detected scene information, time information thereof, and further detailed information is generated as metadata and used as information related to the input video.

In the above-described information processing apparatus, on a scene as a detection target with respect to the input video, the control unit may compare time information obtained as the first result information and time information provided as external data, and, in a case of discrepancy, may perform processing of overwriting the time information provided as the external data with the time information obtained as the first result information.

For example, with respect to a timecode or the like of the scene, external data provided like STATS data is rewritten according to an analysis result.

In the above-described information processing apparatus, on a scene as a detection target with respect to an input video, the control unit may compare accompanying information obtained as third result information obtained by an analysis engine decided in the third control processing and accompanying information provided as external data, and, in a case of discrepancy, may perform processing of overwriting the accompanying information provided as the external data with the accompanying information obtained as the third result information.

For example, with respect to accompanying information of the scene, external data provided like STATS data is rewritten according to an analysis result.

In the above-described information processing apparatus, the control unit may select or generate image information corresponding to the scene obtained as the first result information, and may perform processing of combining the image information with the input video.

For example, an image corresponding to the scene is generated, or a suitable image is selected from among prepared images. Such an image is combined with the input video.

In the above-described information processing apparatus, the second result information may include time information related to the scene obtained as the first result information, and the control unit may perform processing of superimposing the image information on the input video on the basis of time information obtained from the first result information or from the second result information.

For example, in a case where an image corresponding to the scene is combined, a section to be combined is set according to time information obtained from an analysis result.

An information processing method according to the present technology is an information processing method performed by an information processing apparatus, and includes first control processing of deciding an analysis engine for scene detection from among a plurality of analysis engines on the basis of scene detection information for scene detection with respect to an input video, and second control processing of deciding an analysis engine for obtaining second result information related to the scene from among a plurality of analysis engines, on the basis of scene-related information regarding a scene obtained as first result information by the analysis engine decided in the first control processing.

A program according to the present technology is a program caused to be executed by an information processing apparatus, and includes first control processing of deciding an analysis engine for scene detection from among a plurality of analysis engines on the basis of scene detection information for scene detection with respect to an input video, and second control processing of deciding an analysis engine for obtaining second result information related to the scene from among a plurality of analysis engines, on the basis of scene-related information regarding a scene obtained as first result information by the analysis engine decided in the first control processing.

### BRIEF DESCRIPTION OF DRAWINGS

FIG. 1 is a diagram illustrating an overall configuration example including an information processing apparatus of a present embodiment.

FIG. 2 is a schematic explanatory diagram illustrating a flow of each piece of processing executed on input data.

FIG. 3 is a diagram illustrating a configuration example of the information processing apparatus.

FIG. 4 is a block diagram of the information processing apparatus.

FIG. 5 is a diagram illustrating an example of analysis engines that may be selected in scene detection and parameters to be assigned.

FIG. 6 is a diagram illustrating an example of analysis engines that may be selected in scene extraction and parameters to be assigned.

FIG. 7 is a diagram illustrating an example of analysis engines that may be selected in detail description and parameters to be assigned.

FIG. 8 is a diagram illustrating an example of a generic screen.

FIG. 9 is a diagram illustrating an example of a detection setting screen.

FIG. 10 is a diagram illustrating an example of an image analysis setting screen.

FIG. 11 is a diagram illustrating another example of the image analysis setting screen.

FIG. 12 is a diagram illustrating an example of an extraction setting screen.

FIG. 13 is a diagram illustrating another example of the extraction setting screen.

FIG. 14 is a diagram illustrating still another example of the extraction setting screen.

FIG. 15 is a diagram illustrating even still another example of the extraction setting screen.

FIG. 16 is a diagram for describing a first example of automatic adjustment of the parameters.

FIG. 17 is an example of a flowchart for implementing the first example of the automatic adjustment of the parameters.

FIG. 18 is a diagram for describing a second example of automatic adjustment of the parameters.

FIG. 19 is a diagram for describing a third example of automatic adjustment of the parameters.

FIG. 20 is a diagram for describing a fourth example of automatic adjustment of the parameters.

FIG. 21 is an example of a flowchart for implementing the fourth example of the automatic adjustment of the parameters.

FIG. 22 is an example of a functional block diagram included in the information processing apparatus to generate a highlight video.

FIG. 23 is an example of a functional block diagram included in the information processing apparatus to perform real-time distribution.

### MODE FOR CARRYING OUT THE INVENTION

Hereinafter, embodiments will be described in the following order.

<1. Overall configuration>

<2. Overview of processing of information processing apparatus>

<3. Configuration of information processing apparatus>

<4. Analysis engines and parameters used in each phase>

<4-1. Analysis engines>

<4-2. Scene detection>

<4-3. Scene extraction>

<4-4. Detail description>

<5. Parameter specification by operator>

<6. Automatic adjustment of parameters>

<6-1. First example>

<6-2. Second example>

<6-3. Third example>

<6-4. Fourth example>

<7. Functional block for performing real-time analysis processing>

<7-1. Highlight-video generation>

<7-2. Real-time distribution>

<8. Others>

<9. Conclusion>

<10. Present technology>

### 1. Overall Configuration

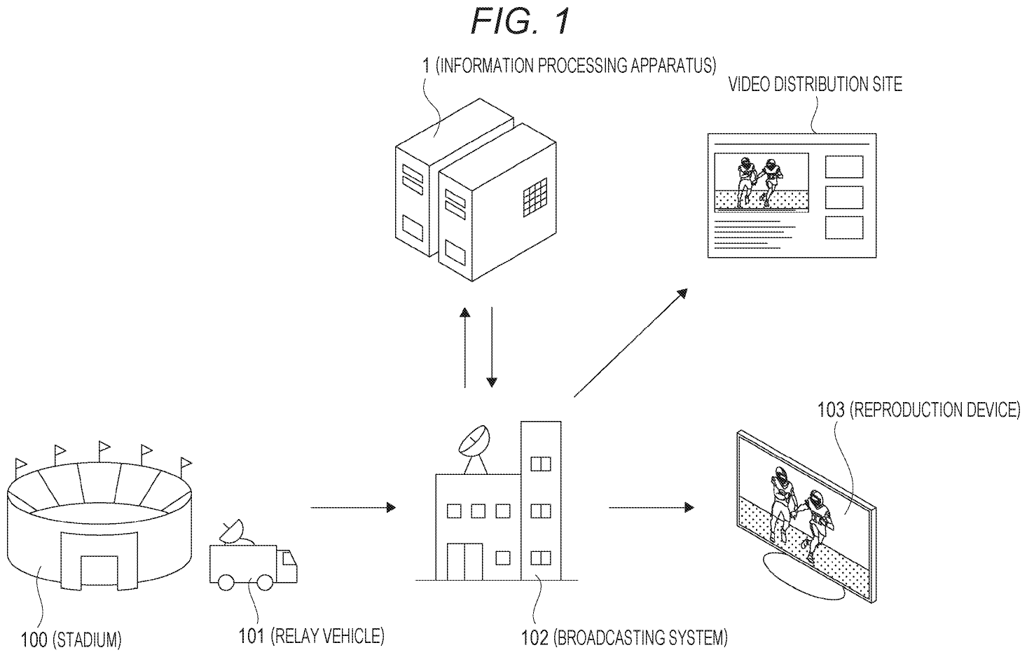

FIG. 1 illustrates an overall configuration including an information processing apparatus 1 according to an embodiment. Note that the configuration illustrated in FIG. 1 is an example of a configuration for creating a highlight video or the like while live broadcasting a sport game played in a stadium. However, implementation of the present technology is not limited to the form. For example, various modes are conceivable such as uploading data of a moving image captured by a photographer to the information processing apparatus 1 and setting each parameter to create a highlight video of the uploaded moving image data, extract only a specific scene, or extract text data from audio data included in the moving image data.

One or a plurality of imaging apparatuses (not illustrated) are arranged in a stadium 100. Data of a moving image or still image captured by the imaging apparatus is transmitted to a relay vehicle 101 located near the stadium 100.

The relay vehicle 101 includes a switcher that switches an antenna device used for transmission and reception of data, a camera control unit (CCU) that controls an imaging apparatus, and an imaging apparatus used for broadcasting or video recording, a monitor apparatus for checking a screen image, and the like. The moving image data (relayed screen-image data) created at the relay vehicle 101 is transmitted to, for example, a broadcasting system 102 owned by a broadcaster.

While appropriately switching a screen image relayed from the relay vehicle 101 and a screen image of a studio, the broadcasting system 102 distributes moving image data to a reproduction device 103 such as a television receiver provided in each home, a mobile terminal, or the like. With this arrangement, with the reproduction device 103, it is possible to view and listen a live broadcast of a sport game being played in the stadium 100.

Furthermore, the relayed screen-image data is not only used for live broadcasting but also processed for a highlight video or the like utilized for sports news or the like later. Therefore, an operator uploads the moving image data serving as the relayed screen-image data to the information processing apparatus 1. Furthermore, various parameters for deciding what kind of highlight video is desired to be created are transmitted to the information processing apparatus 1.

On the basis of the received moving image data and parameters, the information processing apparatus 1 executes various kinds of processing as described later, and transmits a processing result to the broadcasting system 102.

Information of the processing result transmitted from the information processing apparatus 1 to the broadcasting system 102 may be metadata for editing the relayed screen-image data, edited moving image data (for example, highlight video), or the like. In a case where the metadata is transmitted, the metadata is transmitted as information associated with the moving image data input (uploaded) to the information processing apparatus 1. For example, the metadata is transmitted in association with time stamp information in the input moving image data.

In a case where the information processing apparatus 1 transmits the metadata to the broadcasting system 102, processing of editing the relayed screen-image data into final moving image data is executed in the broadcasting system 102. In the following description, an example in which the information processing apparatus 1 transmits the metadata to the broadcasting system 102 will be described.

The broadcasting system 102 uploads the received highlight video or a highlight video generated on the basis of the received metadata to, for example, a video distribution site.

With this arrangement, a user can view and listen the highlight video.

### 2. Overview of Processing of Information Processing Apparatus

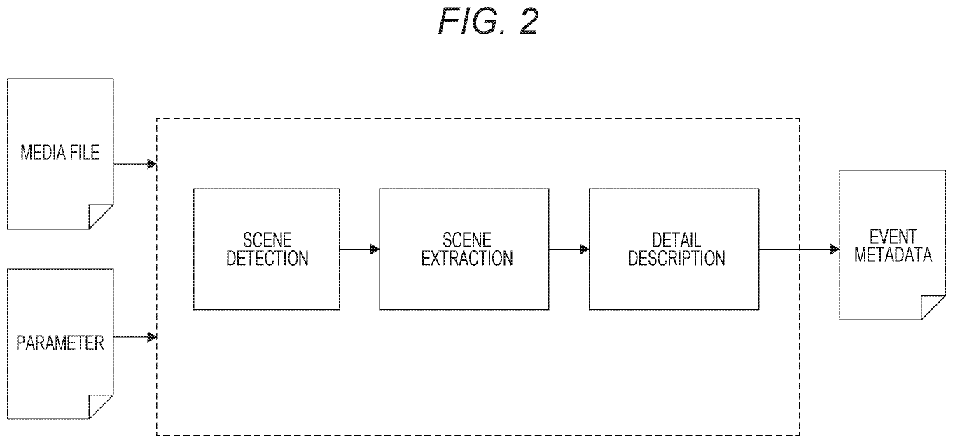

An overview of processing executed by a control unit 10 included in the information processing apparatus 1 will be described with reference to FIG. 2. Note that a part surrounded by a broken line illustrated in FIG. 2 is processing executed by the information processing apparatus 1.

From the broadcasting system 102 for example, the information processing apparatus 1 receives a media file serving as moving image data, and a parameter used for processing. First, the information processing apparatus 1 performs scene detection. The scene detection is processing of identifying, from the moving image data, a part in which a specific scene (event) has occurred, and outputting a scene occurrence time as time information. The specific scene is, for example, in a case of an American football (hereinafter simply referred to as “American football”) game, a scene of “Touchdown”, “Field Goal”, “Long Run”, “Quarterback (QB) Sack” or the like.

For example, in a case where a scene of “Touchdown” is detected in the scene detection, a time at a moment of the touchdown is detected as the scene occurrence time as output. Only one piece of information of the scene occurrence time may be output, or pieces of the information of the scene occurrence time may be output as many as the number of detected touchdowns.

Furthermore, in the scene detection, one type of scene may be detected, or a plurality of types of scenes may be detected.

Next, the information processing apparatus 1 performs scene extraction. In a scene extraction phase, a width of time information related to a scene identified with respect to the scene occurrence time identified in a scene detection phase is decided. For example, in the scene extraction, an in-point and an out-point for the identified scene are decided. With this arrangement, a clipping range of the moving image data can be decided.

Finally, the information processing apparatus 1 performs detail description. In the detail description, processing of identifying information to be extracted in the moving image data between the in-point and the out-point of the identified scene is performed. For example, in a case of a scene of a touchdown, a name of a player who has succeeded in the touchdown is identified. Alternatively, if there is a player who passed a ball before, a name of the player is identified.

Thus, the scene occurrence time is identified in the scene detection, the width (clipping range) of the time information related to the scene is identified in the scene extraction, and processing of extracting an important matter in the scene is performed in the detail description.

Note that the detail description is not necessarily executed, and only the scene detection and the scene extraction may be executed to decide the scene occurrence time or the width (clipping range) of the time information related to the scene.

The information obtained in the scene detection, the scene extraction, and the detail description in this manner is transmitted as, for example, metadata to the broadcasting system 102 that is a transmission source of the moving image data.

Note that, other than this, processing up to edition of the moving image data may be performed by the information processing apparatus 1, and the obtained edited moving image data may be transmitted to the broadcasting system 102. Furthermore, the edited moving image data may be transmitted to another information processing apparatus, such as a video distribution site for example, instead of being transmitted to the transmission source.

### 3. Configuration of Information Processing Apparatus

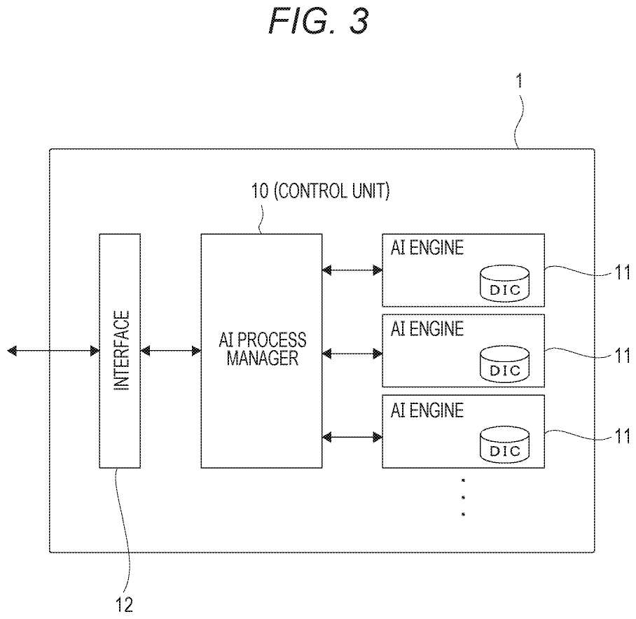

A configuration example of the information processing apparatus 1 is illustrated in FIG. 3.

The information processing apparatus 1 includes an artificial intelligence (AI) process manager serving as the control unit 10, a plurality of analysis engines 11 serving as AI engines, and an interface 12 from which and to which data is input and output.

The analysis engines 11 execute various recognition processing, extraction processing, and determination processing, and function as, for example, a recognizer or extractor with processing accuracy improved by machine learning (deep learning or the like) of AI.

The analysis engines 11 include, for example, a deep neural network, dictionary data (DIC database), and the like.

For example, the interface 12 transfers, to the control unit 10, necessary parameters input from an outside for the analysis engines 11 to execute various kinds of analysis processing and the like, for example. Furthermore, results of analysis using each of the analysis engines 11 are received from the control unit 10 and transferred to an external communication unit or the like.

With this arrangement, the information processing apparatus 1 can perform analysis processing based on the moving image data or parameters received from the broadcasting system 102 and transmit a result of the analysis to the broadcasting system 102.

On the basis of the parameters received from the interface 12, the control unit 10 appropriately executes processing related to the scene detection, processing related to the scene extraction, and processing related to the detail description, described above. For this reason, the control unit 10 selects an optimal analysis engine 11 corresponding to processing content.

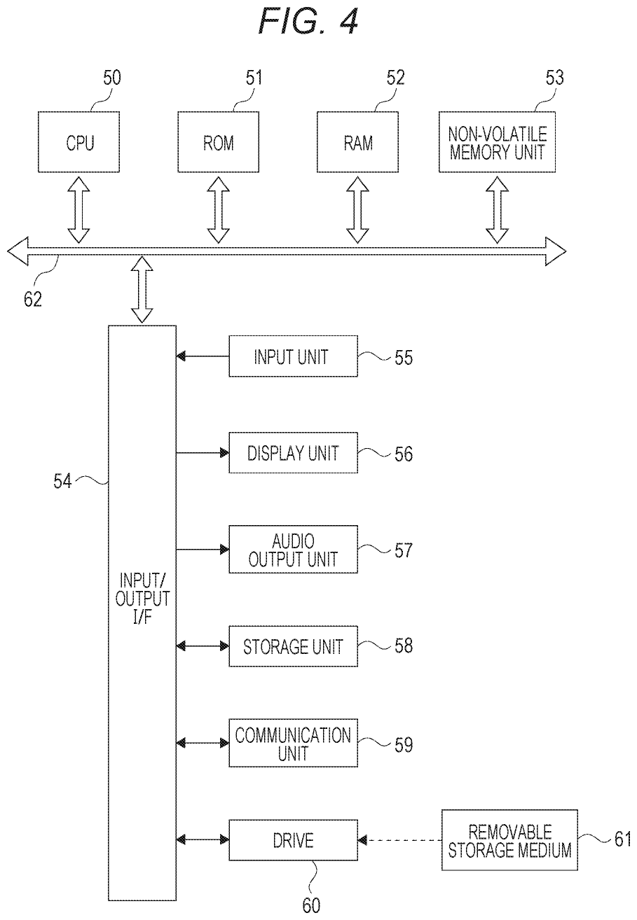

In order for the control unit 10 to execute such processing, the information processing apparatus 1 has a configuration as specifically illustrated in FIG. 4.

The information processing apparatus 1 includes, for example, an information processing apparatus having an arithmetic processing function, such as a general-purpose personal computer, a terminal apparatus, a tablet terminal, or a smartphone.

A CPU 50 of the information processing apparatus executes various kinds of processing according to a program stored in a ROM 51 or a program loaded from a storage unit 58 to a RAM 52. As appropriate, the RAM 52 also stores data necessary for the CPU 50 to execute various kinds of processing.

The CPU 50, the ROM 51, and the RAM 52 are mutually connected via a bus 62. Furthermore, an input/output interface 54 is connected to the bus 62.

An input unit 55 including an operation element and an operation device is connected to the input/output interface 54. For example, as the input unit 55, various operation elements and operation devices such as a keyboard, a mouse, a key, a dial, a touch panel, a touch pad, and a remote controller are assumed. Alternatively, audio input or the like may be possible.

Operation by the operator is sensed by the input unit 55, and a signal corresponding to the input operation is interpreted by the CPU 50.

Furthermore, a display unit 56 including an LCD, an organic EL panel, or the like is integrally or separately connected to the input/output interface 54.

The display unit 56 is a display unit that performs various displays, and includes, for example, a display device provided in a housing of the information processing apparatus, a separate display device connected to the information processing apparatus, or the like.

The display unit 56 executes display of various user interface (UI) screens, a screen image of movie content, or the like on a display screen on the basis of an instruction from the CPU 50. Furthermore, on the UI screen, various operation menus, icons, messages, and the like are displayed on the basis of an instruction from the CPU 50.

The storage unit 58 including a hard disk, a solid-state memory, or the like, and a communication unit 59 including a modem or the like are connected to the input/output interface 54.

The communication unit 59 performs communication with communication processing via a transmission line such as the Internet, wired/wireless communication with various devices, bus communication, or the like.

Furthermore, a drive 60 is also connected to the input/output interface 54 as necessary, and a removable storage medium 61, such as a magnetic disk, an optical disk, a magneto-optical disk, or a semiconductor memory, is appropriately mounted.

The drive 60 can read a data file such as an image file, various computer programs, and the like from the removable storage medium 61. The read data file is stored in the storage unit 58, and an image or audio included in the data file is output by the display unit 56. Furthermore, a computer program or the like read from the removable storage medium 61 is installed in the storage unit 58 as necessary.

In this information processing apparatus, for example, software for processing in the present disclosure can be installed via network communication by the communication unit 59 or the removable storage medium 61. Alternatively, the software may be stored in advance in the ROM 51, the storage unit 58, or the like.

For example, such software constructs a configuration for implementing various functions in the CPU 50 of each information processing apparatus.

### 4. Analysis Engines and Parameters Used in Each Phase

### 4-1. Analysis Engines

As described above, the information processing apparatus 1 selects one or a plurality of analysis engines 11 from among a plurality of analysis engines 11 in order to detect a specific scene in the scene detection, and utilizes the selected analysis engine 11. Similarly, the information processing apparatus 1 selects one or a plurality of analysis engines 11 in order to decide a scene clipping range in the scene extraction. Moreover, the information processing apparatus 1 selects one or a plurality of analysis engines 11 in order to extract detailed information regarding a scene in the detail description.

The selected analysis engine 11 may be implemented in the information processing apparatus 1 or may be included in an information processing apparatus or the like other than the information processing apparatus 1.

There is a case where a parameter is set to the analysis engine 11 in order to detect a specific scene in the scene detection phase. The parameter may be received from the broadcasting system 102 together with the media file, or may be set in the analysis engine 11 by the information processing apparatus 1 on the basis of information received from the broadcasting system 102.

For example, it is conceivable that the operator specifies “Touchdown” as a scene to be extracted. In this case, the information processing apparatus 1 assigns received information specifying “Touchdown” to the analysis engine 11 as a parameter.

Alternatively, it is assumed that the operator wishes to extract an exciting scene regardless of a scene type. In this case, the operator selects, from among a plurality of options, an option indicating that an exciting scene is extracted as a detection target.

The information processing apparatus 1 that has received this information may assign the analysis engine 11 with a parameter for setting “Touchdown”, “Field Goal”, or “QB Sack” as a detection target scene.

That is, the parameter specified by the operator may be directly provided as is to the analysis engine 11, or the parameter selected by the information processing apparatus 1 on the basis of the information specified by the operator may be provided to the analysis engine 11.

An example of classification of the analysis engines 11 by purpose will be described.

### [Audio Captioning Engine]

An audio captioning engine is an analysis engine 11 that performs processing of analyzing audio data and extracts text data. A parameter assigned to the audio captioning engine is, for example, a parameter for specifying a language, or the like.

### [Object Recognition Engine]

An object recognition engine is an analysis engine 11 that recognizes an object such as a human, an animal, or an object that is caught in the moving image data. A parameter assigned to the object recognition engine is, for example, a parameter for specifying a type of the object, or the like.

### [Character Recognition Engine]

A character recognition engine is an analysis engine 11 that detects a character that is caught in or superimposed on the moving image data. A parameter assigned to the character recognition engine is, for example, a parameter for specifying a type of a language (English, Japanese, or the like), or the like.

### [Face Recognition Engine]

A face recognition engine is an analysis engine 11 that recognizes a face region of a person who is caught in the moving image data. A parameter assigned to the face recognition engine is, for example, a parameter for specifying a specific person or a specific gender, or the like.

### [Sports Data Analysis Engine]

A sports data analysis engine is, for example, an analysis engine 11 that analyzes statistics (STATS) information provided outside the information processing apparatus 1. The STATS information may include, for example, text information indicating progress of a game, numerical information indicating performance of a player in a specific period, and the like. A parameter assigned to the sports data analysis engine is, for example, information for identifying a player, information for identifying a scene, or the like.

### [Highlight Generation Engine]

The highlight generation engine is an analysis engine 11 that extracts a scene to be a highlight of the game. For example, a highlight video may be generated in cooperation with an excitement detection engine as described later. Furthermore, the highlight generation engine may extract time information for generating the highlight video without generating the highlight video.

A parameter assigned to the highlight generation engine is, for example, a parameter for specifying a time length of the highlight video, a parameter for identifying a player in order to generate a highlight video of a specific player, or the like.

### [Time-Saving Version Generation Engine]

A time-saving version generation engine is an analysis engine 11 that generates a time-saving version of the moving image data. For example, the time-saving version generation engine performs processing of identifying a scene of game interruption, or the like in order to exclude the scene of the game interruption.

A parameter assigned to the time-saving version generation engine is, for example, a parameter specifying a time length of time-saving version moving image data, a parameter identifying an unnecessary scene, or the like.

### [Emotion Recognition Engine]

An emotion recognition engine is an analysis engine 11 that estimates emotion by analyzing a shape or the like of each part of a face of a person who is caught in the moving image data. The emotion recognition engine may have a function of the face recognition engine to analyze emotion, or may cooperate with the face recognition engine to analyze emotion of a subject.

A parameter assigned to the emotion recognition engine is a parameter for identifying a player, a parameter for identifying a team, or the like.

### [Excitement Detection Engine]

The excitement detection engine is an analysis engine 11 that analyzes whether or not a scene is of excitement. A parameter assigned to the excitement detection engine is a volume parameter serving as a threshold value for determining whether or not a scene is of excitement, or the like.

### [Camera Angle Recognition Engine]

A camera angle recognition engine is an analysis engine 11 that identifies a camera angle and recognizes a change in camera angle. A parameter assigned to the camera angle recognition engine is, for example, a parameter for specifying a zoom-out screen image, a parameter for specifying an angle of view, or the like.

Furthermore, the camera angle recognition engine is also an engine that detects how large the subject is appearing in the screen image, that is, whether a certain player is being zoomed in on, or a game overall is being shot. For example, information of a skeleton of a person is acquired by image recognition, and in a case where the acquired information indicates that the skeleton has a certain degree of size and is of only an upper body, an analysis result indicating a bust shot is obtained.

### [Pan-Tilt Recognition Engine]

A pan-tilt recognition engine is an analysis engine 11 that recognizes panning and tilting of the camera. A parameter assigned to the pan-tilt recognition engine is, for example, a parameter for specifying either pan or tilt, a parameter for specifying a change in angle, or the like.

Thus, the information processing apparatus 1 can utilize various analysis engines 11.

Note that these various analysis engines 11 may be provided for every sport type. For example, as the object recognition engines, there may be provided an analysis engine 11 for American football, the analysis engine 11 being dedicated to recognition of players, balls, goalposts, and the like of American football, and an analysis engine 11 for soccer, the analysis engine 11 being dedicated to recognition of players, balls, goals, and the like of soccer.

### 4-2. Scene Detection

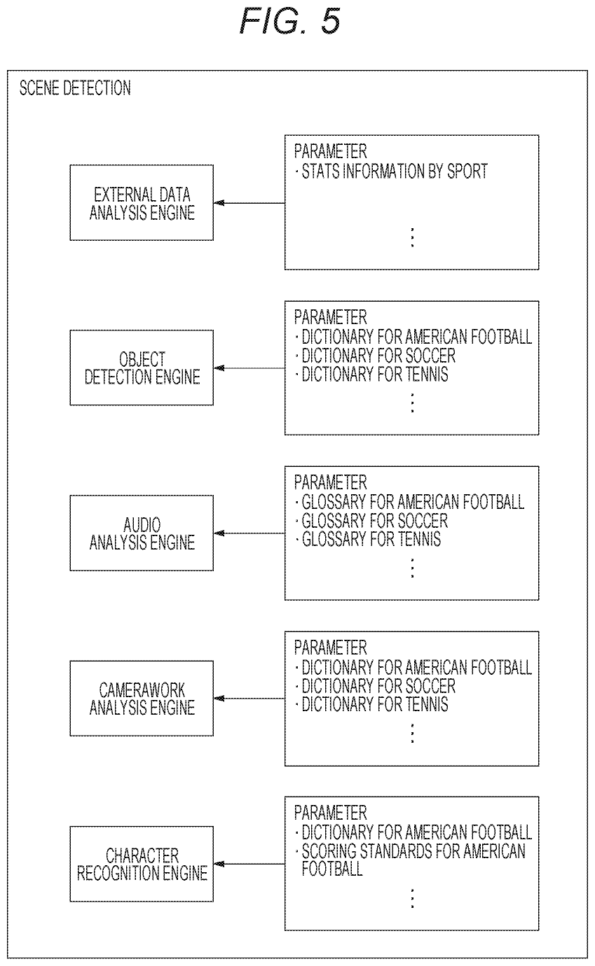

FIG. 5 illustrates an example of the analysis engines 11 and parameters used to execute scene detection.

On the basis of processing content, the analysis engines 11 used for scene detection are classified into an external data analysis engine, an object detection engine, an audio analysis engine, a camerawork analysis engine, the character recognition engine, and the like. Note that another analysis engine 11 may be selected in the scene detection.

The external data analysis engine analyzes information acquired from outside of the information processing apparatus 1 and performs processing that contributes to identification of a scene occurrence time, and corresponds to, for example, the above-described sports data analysis engine or the like.

A parameter assigned to the external data analysis engine is, for example, STATS information by sport, or the like.

The object detection engine performs processing of analyzing what is appearing in an image by performing image analysis, and corresponds to, for example, the above-described object recognition engine or the like. Specifically, the object detection engine identifies a ball, person, tool used for the sport, and the like that appears in the image. Furthermore, a subtitle superimposed on the image, or a superimposed image, such as a character image or a 3D image, may be identified.

The excitement detection engine that identifies spectators and analyzes expression, movement, and the like thereof to determine whether or not the spectators in a venue are excited, the emotion recognition engine that identifies a face of a player with image analysis and analyzes expression in the face, and the like are also referred to as object detection engines, because the engines perform recognition processing of spectator seats or recognition processing of a face region.

A parameter assigned to the object detection engine is, for example, a dictionary for American football, a dictionary for soccer, a dictionary for tennis, or the like. That is, by providing different dictionaries as parameters for the respective sports, the object detection engine functions as an object detection engine for American football or an object detection engine for soccer.

The audio analysis engine performs processing of analyzing audio data, and corresponds to, for example, the above-described audio captioning engine. Note that the excitement detection engine that detects excitement in the venue by analyzing a change in volume of audio can also be said to be an audio analysis engine.

A parameter assigned to the audio analysis engine is, for example, a glossary for American football, a glossary for soccer, a glossary for tennis, or the like. That is, by providing different glossaries as parameters for the respective sports, the audio analysis engine functions as an audio analysis engine for American football or an audio analysis engine for soccer.

The camerawork analysis engine performs processing of identifying and analyzing a change in an angle of view, and corresponds to, for example, the above-described camera angle recognition engine or pan-tilt recognition engine. Note that the excitement detection engine that detects excitement in the venue by analyzing camerawork can also be said to utilize the camerawork analysis engine.

A parameter assigned to the camerawork analysis engine is, for example, the dictionary for American football, the dictionary for soccer, or the like.

The character recognition engine performs character recognition processing with respect to a subtitle or displayed scores superimposed on the image, and for example, detects a touchdown scene by performing character recognition processing on an image on which decorative characters “TOUCHDOWN” are superimposed. Alternatively, the character recognition engine can identify a change in a score superimposed as a subtitle by character recognition, and, according to an amount of change in a score, estimate a scene that has occurred, or the like.

For example, the character recognition engine can also function as an excitement detection engine that estimates a degree of excitement by performing scene detection based on the character recognition processing.

A parameter assigned to the character recognition engine is, for example, the dictionary for American football, scoring standards for American football, or the like.

These parameters may be assigned according to not only by sport type but also by scene type. For example, for an American football game, a parameter for detecting a scene of a touchdown and a parameter for detecting a field goal may be different.

### 4-3. Scene Extraction

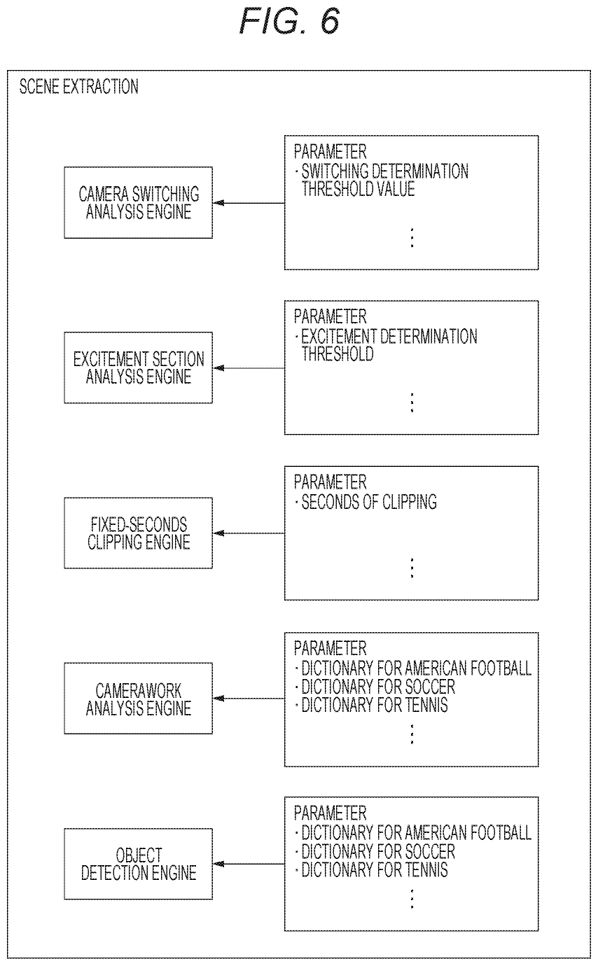

FIG. 6 illustrates an example of the analysis engines 11 and parameters used to execute scene extraction.

On the basis of processing content, the analysis engines 11 used for scene extraction are classified into a camera switching analysis engine, an excitement section analysis engine, a fixed-seconds clipping engine, the camerawork analysis engine, the object detection engine, and the like. Note that, as in an example described later, another analysis engine 11 may be selected in the scene extraction.

The camera switching analysis engine analyzes whether or not the switcher switches between the imaging apparatuses, a switching timing of the switcher, and the like. The camera switching analysis engine may function to detect an end of an excitement section by detecting frequent switching operations, or may be, by detecting a switching timing, used for decision of a scene clipping range by the highlight generation engine.

A parameter assigned to the camera switching analysis engine is, for example, a threshold value for performing switching determination, or the like.

The excitement section analysis engine performs processing of deciding a clipping range of a scene of excitement, and functions as the above-described excitement detection engine.

A parameter assigned to the excitement section analysis engine is, for example, a threshold value for determining whether or not the scene is of excitement, or the like.

The fixed-seconds clipping engine performs processing of clipping a range before and after a specified time, and is utilized by the above-described highlight generation engine, the time-saving version generation engine, and the like.

A parameter assigned to the fixed-seconds clipping engine is, for example, a scene occurrence time, seconds of clipping, or the like.

The camerawork analysis engine performs processing of identifying and analyzing a change in an angle of view, and corresponds to the above-described camera angle recognition engine or pan-tilt recognition engine. In a case where a highlight video or a short-version video is generated by using a result of analyzing camerawork, the camerawork analysis engine is utilized by the highlight generation engine or a short-version generation engine.

A parameter assigned to the camerawork analysis engine is, for example, the dictionary for American football, the dictionary for soccer, or the like.

Because the object detection engine has been described in the scene detection, description thereof is omitted.

### 4-4. Detail Description

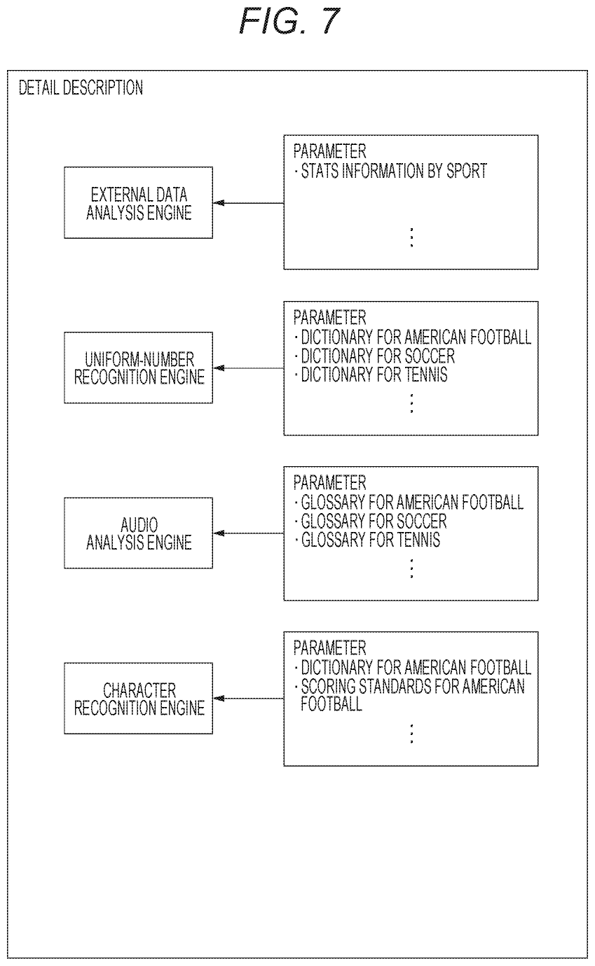

FIG. 7 illustrates an example of the analysis engines 11 and parameters used to execute detail description.

On the basis of processing content, the analysis engines 11 used for detail description are classified into the external data analysis engine, a uniform-number recognition engine, the audio analysis engine, the character recognition engine, and the like. Note that, as in an example described later, another analysis engine 11 may be selected in the detail description.

The external data analysis engine is similar to the external data analysis engine described in the scene detection.

By performing image analysis, the uniform-number recognition engine performs processing of recognizing a uniform number (uniform number) of the player appearing in the image. This processing is executed, for example, to identify a key person in an important play. The uniform-number recognition engine is used for the highlight generation engine, the time-saving version generation engine, and the like.

A parameter assigned to the uniform-number recognition engine is, for example, the dictionary for American football, the dictionary for soccer, or the like.

The audio analysis engine performs processing of analyzing audio data, and is utilized, for example, to identify a key person in an important play. Accordingly, the audio analysis engine is utilized by the highlight generation engine, the time-saving version generation engine, and the like.

A parameter assigned to the audio analysis engine is, for example, the glossary for American football, the glossary for the soccer, or the like. Alternatively, a parameter for identifying a language may be assigned.

The character recognition engine performs processing of detecting, from the image, text information including the superimposed subtitle and the like, and is utilized, for example, to extract detailed information (accompanying information) of content of a play performed. For example, in a case of an image of an American football game, a yard mark is superimposed for every certain yard from a center line, and the character recognition engine is utilized to calculate how far a player has moved the ball forward from a yard mark, that is, how many yards the player has picked up in a long run.

A parameter assigned to the character recognition engine is, for example, the dictionary for American football, scoring standards for American football, or the like.

### 5. Parameter Specification by Operator

Specification of a parameter by the operator is performed by using, for example, a user interface (UI).

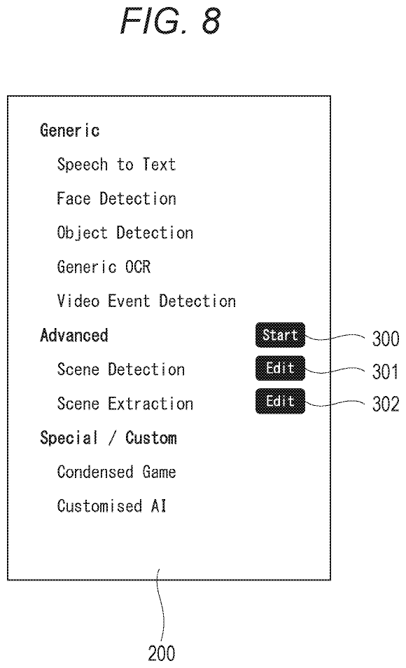

For example, in specification the parameter, first, a generic screen 200 as illustrated in FIG. 8 is provided to the operator.

On the generic screen 200, items for setting how to analyze the moving image data are arranged. Therein, an advanced button 300, a first setting button 301, and a second setting button 302 are arranged as operation elements for deciding scenes to be extracted in the scene detection and the scene extraction.

The first setting button 301 is an operation element for displaying a detection setting screen 201 for setting a parameter (scene detection information) for detecting a desired scene in the scene detection.

The second setting button 302 is an operation element for displaying an extraction setting screen (described later) for setting a parameter (scene-related information) for deciding a scene clipping range in a desired mode in the scene extraction.

The advanced button 300 is, for example, an operation element for displaying a screen for setting both the parameters (scene detection information and scene-related information) utilized in the scene detection and the scene extraction.

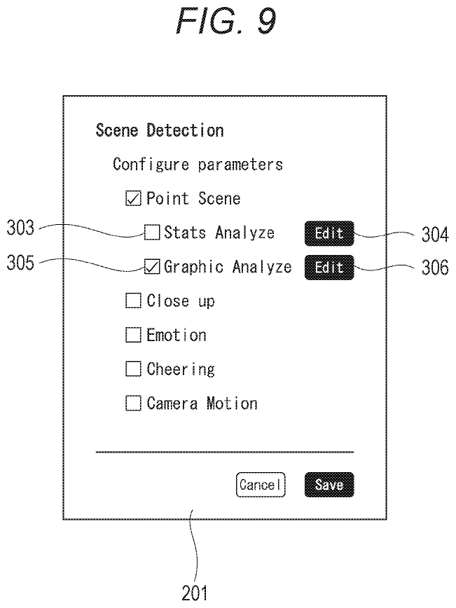

FIG. 9 illustrates an example of the detection setting screen 201.

Parameter setting operation elements for detecting a desired scene are arranged on the detection setting screen 201.

Specifically, a checkbox (“Point Scene” in the drawing) indicating whether or not to specify a scene type is arranged. Furthermore, a STATS Analyze checkbox 303 and an Edit button 304, and a Graphic Analyze checkbox 305 and an Edit button 306, which are selectable in a case where the “Point Scene” checkbox is in an ON state, are arranged.

In addition, the detection setting screen 201 is provided with a checkbox (“Close Up” in the drawing) for setting whether or not to detect a specific scene on the basis of a scene on which the camera zooms in, a checkbox (“Emotion” in the drawing) for setting whether or not to detect a scene on the basis of an expression of a person such as a player, a checkbox (“Cheering” in the drawing) for setting whether or not to detect a scene on the basis of cheers, a checkbox (“Camera Motion” in the drawing) for setting whether or not to detect a scene on the basis of a motion of the camera such as a camera angle or a panning or tilting of the camera, and the like.

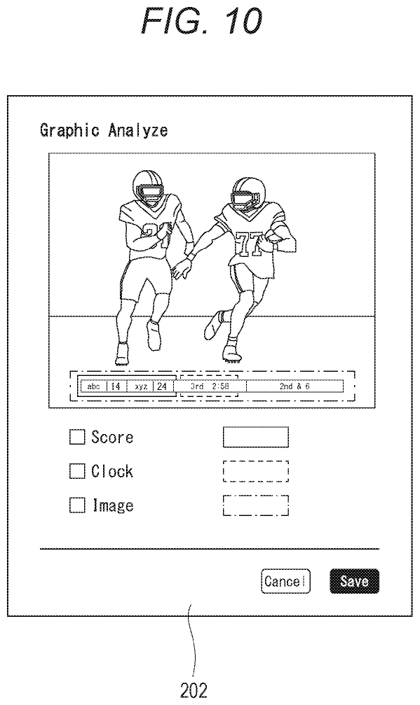

When the Graphic Analyze checkbox 305 is set to ON and the Edit button 306 is pressed, an image analysis setting screen 202 illustrated in FIG. 10 is displayed. Arranged on the image analysis setting screen 202 are, a Score checkbox 307 for specifying whether or not to acquire score information from subtitle information superimposed on the image, a Time checkbox 308 for specifying whether or not to acquire time information from the subtitle information, and a Superimposed character image checkbox 309 for specifying whether or not to analyze a superimposed decorative character image such as “TOUCHDOWN”.

Furthermore, on the image analysis setting screen 202, more detailed parameter specification may be possible.

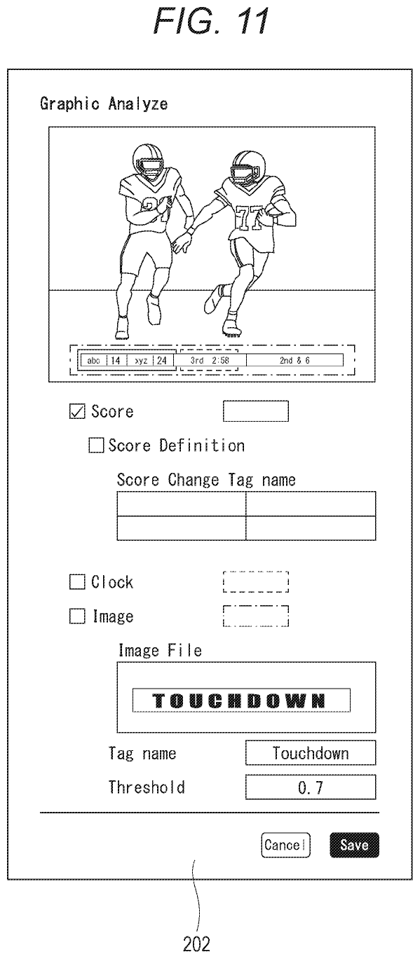

Specifically, FIG. 11 illustrates another example of the image analysis setting screen 202.

On the image analysis setting screen 202, more detailed parameters can be set in scene detection processing based on a score. As illustrated in the drawing, it is possible to set not only the Score checkbox but also what tag name is assigned according to an added score in a case where a change in a score is detected.

Furthermore, in order to specify the analysis of the superimposed character image in further detail, the image analysis setting screen 202 is provided with an operation element for specifying the superimposed character image, an input field for specifying a tag name to be assigned to the corresponding scene, a field for specifying a threshold value used for analysis, and the like.

Note that, the detection setting screen and the image analysis setting screen are provided with an operation element for saving a specified state (set state) to easily reuse a specified parameter, and an operation element for canceling.

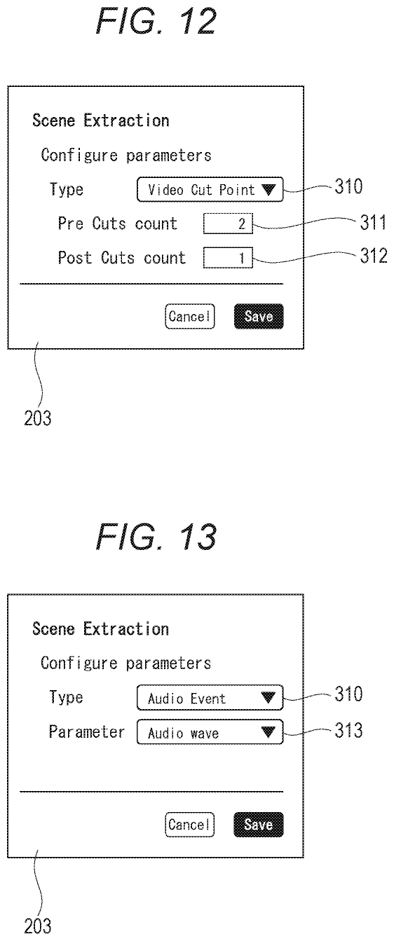

When the second setting button 302 illustrated in FIG. 8 is pressed, an extraction setting screen 203 illustrated in FIG. 12 is displayed.

On the extraction setting screen 203, a parameter setting operation element for deciding a clipping range of the detected scene is arranged.

Specifically, an analysis type selection field 310 for specifying an analysis type is arranged.

In the extraction setting screen 203, items displayed in a lower part vary depending on an option selected in the analysis type selection field 310.

Specifically, a display mode illustrated in FIG. 12 is a display mode in a case where “Video Cut Point” is selected in the analysis type selection field 310. In addition, “Audio Event”, “Fixed Length”, or “None” can be selected in the analysis type selection field 310.

In a case where “Video Cut Point” is selected, there are arranged, on the extraction setting screen 203, a Pre Cuts count input field 311 with which the number of cuts to be changed before the scene occurrence time can be specified, and a Post Cuts count input field 312 with which the number of cuts to be changed after the scene occurrence time can be specified (refer to FIG. 12).

In a case where “Audio Event” is selected, an audio data type selection field 313 with which a type of audio data can be identified is arranged on the extraction setting screen 203 (refer to FIG. 13).

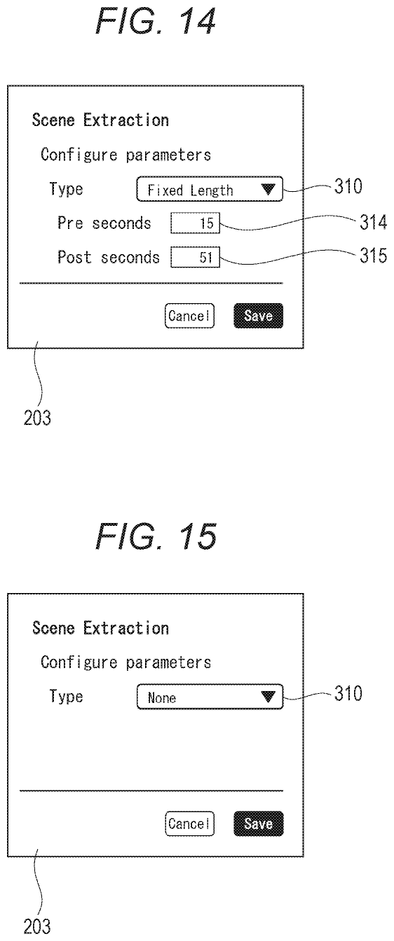

In a case where “Fixed Length” is selected, there are arranged, on the extraction setting screen 203, a Pre seconds input field 314 for specifying an in-point for the scene occurrence time, and a Post seconds input field 315 for specifying an out-point for the scene occurrence time (refer to FIG. 14).

In a case where “None” is selected, other operation elements, such as selection fields and input fields, are not arranged on the extraction setting screen 203 (refer to FIG. 15). In this case, the scene extraction processing may be executed on the basis of tendency so far, or processing of automatically deciding the scene clipping range may be performed on the basis of a learning result of an analysis engine 11 selected in the scene extraction.

As specifically described with reference to each drawing, the operator can specify parameters to be assigned to the analysis engines 11 via an interface such as the UI.

### 6. Automatic Adjustment of Parameters

The parameters assigned to the analysis engines 11 may be automatically adjusted regardless of specification by the operator.

Some examples are described below.

### 6-1. First Example

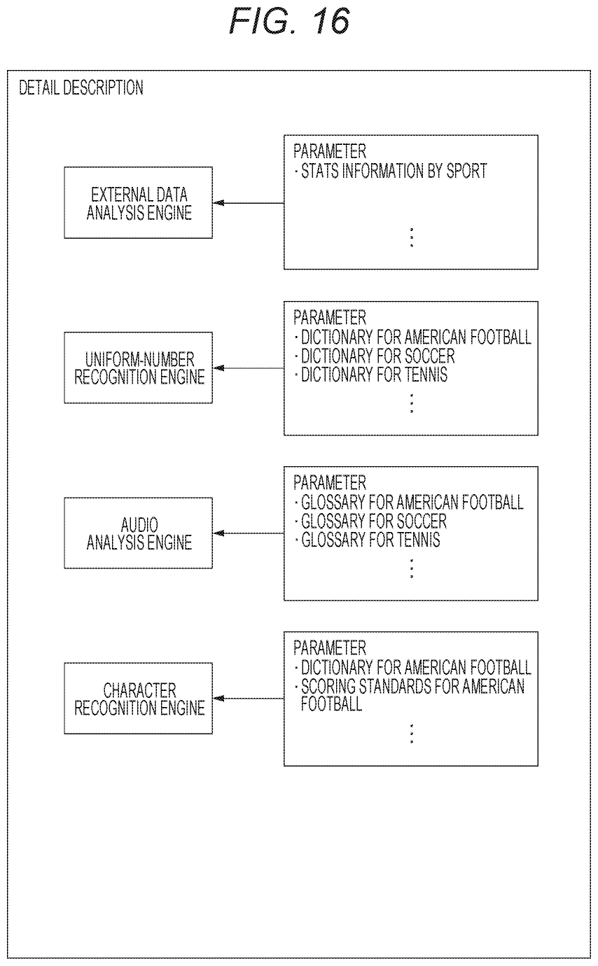

A first example of automatic parameter adjustment is illustrated in FIG. 16.

The first example of the automatic parameter adjustment is an example in which a parameter is automatically assigned when analysis processing using an analysis engine 11 is performed on the moving image data obtained by capturing the image of the American football game.

In the scene detection, first, STATS information is analyzed by using the external data analysis engine. With this arrangement, the scene occurrence time is identified. Note that, in the present example, a scene to be extracted is a scene of “QB Sack”, “Touchdown”, “Field Goal”, “Long Run” or the like, for example.

Next, in the scene extraction, different analysis engines 11 are automatically selected for each type of the scenes detected in the scene detection. Furthermore, parameters assigned to the analysis engines 11 at that time are also automatically selected.

For example, in a case where the scene type is “QB Sack”, the camera switching analysis engine is selected in detection of both the in-point and out-point for deciding a scene clipping range. Furthermore, a parameter for appropriately identifying the clipping range of the scene of “QB Sack” is automatically selected by the camera switching analysis engine. Because it is rare that switching of the cameras is performed during the QB sack, a period from a time when the switching of the cameras is performed to a time when a next switching is performed can be identified as a scene clipping range.

Furthermore, in a case where the scene type is “Touchdown”, the object detection engine is selected in the detection of the in-point. Specifically, the in-point is decided by the object detection engine detecting a huddle scene, which is a scene where players gather between the plays. Furthermore, a parameter for appropriately deciding the in-point is automatically selected and assigned to the object detection engine.

Then, the camerawork analysis engine is selected in the detection of the out-point. In a case of a successful touchdown in American football, it is common to have opportunity to score another point with kicking. In this case, the camera follows the ball released by the kick, and therefore a tilting of the camera occurs. Accordingly, a time point of the occurrence of a tilt-down of the camera detected by the camerawork analysis engine is set as the out-point. Furthermore, a parameter for appropriately deciding the out-point is automatically selected and assigned to the camerawork analysis engine.

Moreover, in a case where the scene type is “Field Goal”, the camerawork analysis engine is selected in detection of both the in-point and the out-point. In a field goal, the camera tilts up and tilts down by following the kicked ball. The tilt-up is detected in the detection of the in-point, and the tilt-down is detected in the detection of the out-point. Furthermore, a parameter for appropriately deciding the in-point and out-point in a “Field Goal” scene is automatically selected and assigned to the camerawork analysis engine.

Furthermore, in a case where the scene type is “Long Run”, the excitement section analysis engine is selected in detection of both the in-point and the out-point. Because a long run is a scene where the spectators are excited, a time point at which the excitement starts is detected as the in-point, and a time point at which the excitement ends is detected as the out-point. Furthermore, a parameter for appropriately deciding the in-point and out-point in a “Long Run” scene is automatically selected and assigned to the excitement section analysis engine.

Thus, the selected analysis engine 11 may be different or the same depending on the scene type. In a case where the same analysis engine 11 is selected, processing efficiency is improved.

In the detail description, detailed information is extracted by using the external data analysis engine. With this arrangement, additional information about the extracted scene is acquired.

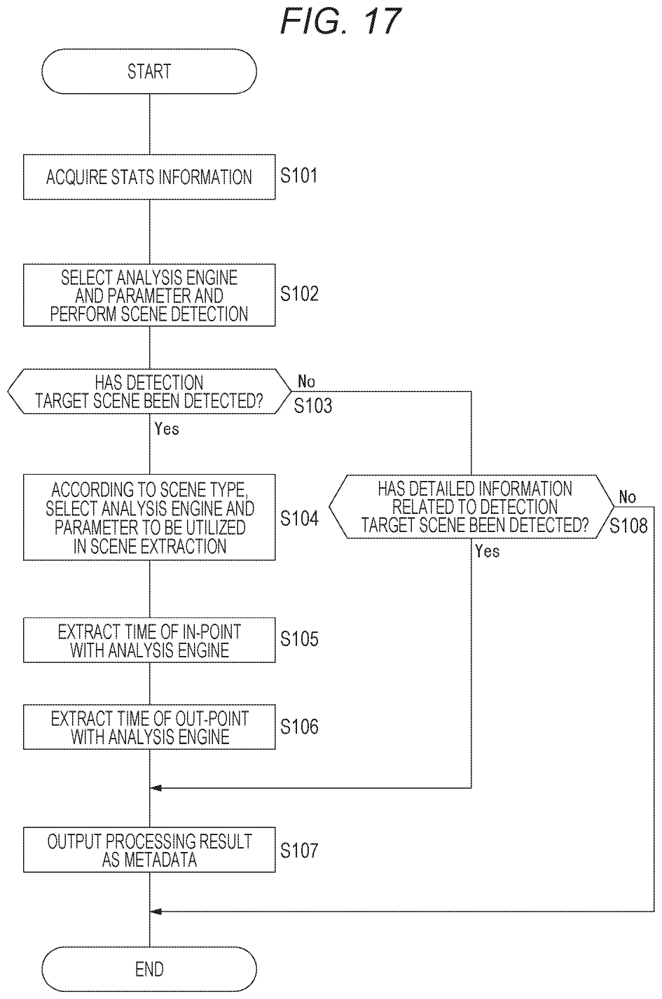

FIG. 17 illustrates a flow of processing executed by the control unit 10 in the first example.

In Step S101, the control unit 10 acquires the STATS information.

Subsequently, in Step S102, the control unit 10 performs scene detection processing on the acquired STATS information. That is, the detection target scene is detected from the acquired STATS information.

Next, in Step S103, the control unit 10 performs split processing corresponding to the detection result of the scene detection. Specifically, it is determined whether or not the detection target scene has been detected in the scene detection.

In a case where the acquired STATS information indicates detection of the detection target scene, the control unit 10 selects in Step S104 an analysis engine 11 and parameter to be used in the scene extraction, according to the scene type. That is, according to the scene type, the analysis engine 11 suitable for detecting the in-point and the out-point is selected, and a parameter is assigned.

Subsequently, in Step S105, the control unit 10 performs in-point detection processing using the selected analysis engine 11 and parameter, and extracts time information.

Furthermore, in Step S106, the control unit 10 performs out-point detection processing using the selected analysis engine 11 and parameter, and extracts time information.

In Step S107, the control unit 10 outputs the time information of the in-point and out-point as metadata. Furthermore, in Step S107, information such as the scene type and scene occurrence time of the scene acquired in the scene detection executed in the processing in Step S102 is also output as metadata.

Meanwhile, in a case of having determined in Step S103 that the detection target scene has not been detected in the scene detection, the control unit 10 determines in Step S108 whether or not detailed information related to the detection target scene is included. That is, it is determined whether or not it is possible to acquire detailed information that is information supplementing the scene already detected from the acquired STATS information. The detailed information is, for example, as described above, uniform number information or name information of a player who has been active in a corresponding scene, or information indicating content of the play by the player (the number of gained yards, or the like).

In a case of having determined that the detailed information can be acquired, the control unit 10 proceeds to Step S107 and performs processing of outputting the acquired detailed information, the scene type, and the like as metadata.

Furthermore, in a case of having determined in Step S108 that the detailed information cannot be acquired, the control unit 10 ends the series of processing illustrated in FIG. 17.

The control unit 10 appropriately performs the processing illustrated in FIG. 17 every time STATS information is acquired. That is, the processing illustrated in FIG. 17 is executed every time STATS information is acquired as information indicating content of one play. By repeating the processing illustrated in FIG. 17, it is possible to identify an occurrence time of a detection target scene, decide a clipping range, and extract detailed information for moving image data obtained by capturing an image of one game.

In such a mode, for example, in a case where the STATS information is updated in parallel with progress of the game, every time the STATS information is updated, information is acquired in Step S101 and each piece of processing thereafter is executed, and, simultaneously with the progress of the game, detection of the occurrence time of the detection target scene as well as the in-point and the out-point, and extraction of detailed information is executed. For example, information necessary for editing the highlight video in parallel with the progress of the game is provided from the information processing apparatus 1 as metadata. Then, in order to enable edit of the highlight video, the metadata is provided in association with time stamp information of input moving image data, for example, in order to clarify which part of the moving image data the metadata relates to.

### 6-2. Second Example

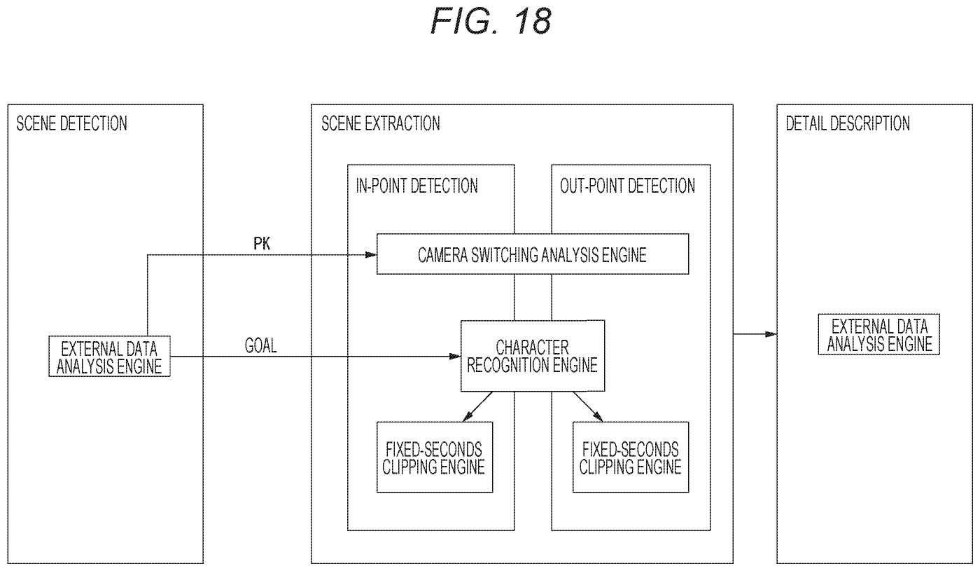

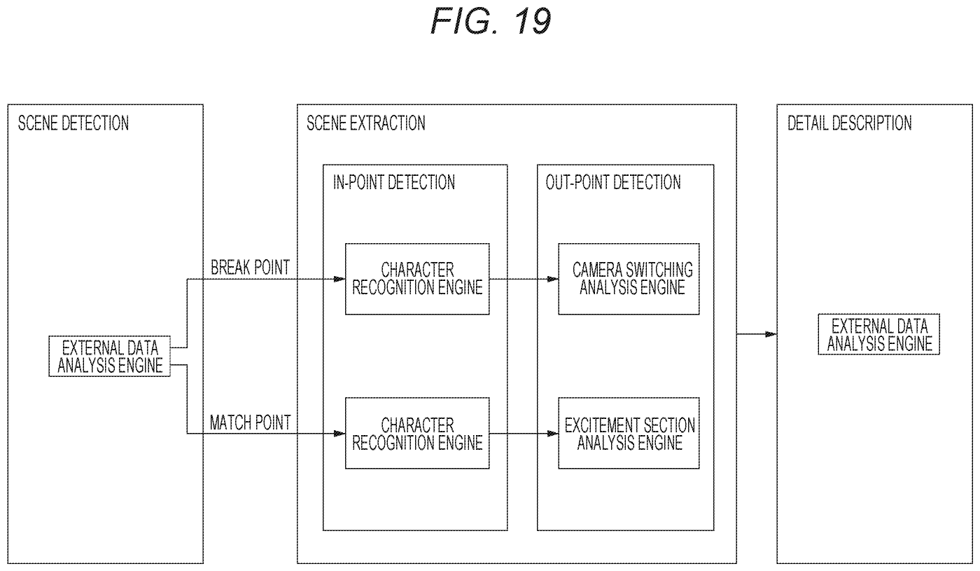

A second example of automatic parameter adjustment is illustrated in FIG. 18. Note that the processing executed by the control unit 10 in the second example is similar to the processing illustrated in FIG. 17, and thus description of a processing flow thereof will be omitted.

The second example is an example in a case where the sport type of an object to be imaged is “Soccer”.

Similarly to a case of American football, in the scene detection, STATS information is analyzed by using the external data analysis engine, and a scene occurrence time is identified. In the present example, a scene to be extracted is a scene of “PK”, “Goal”, or the like, for example.

In the scene extraction, different analysis engines 11 and parameters are automatically selected for each type of the scenes detected in the scene detection.

In a case where the scene type is “PK”, the camera switching analysis engine is selected in detection of both the in-point and the out-point. Furthermore, furthermore, a parameter for appropriately deciding the in-point and out-point in a “PK” scene is automatically selected and assigned to the camera switching analysis engine.

Furthermore, in a case where the scene type is “Goal”, utilization of the character recognition engine and fixed-seconds clipping engine and parameters assigned to the respective analysis engines 11 are automatically decided.

Specifically, first, character recognition using the character recognition engine is performed before detecting the in-point and the out-point, by which score information is acquired from a subtitle of score display superimposed on a captured image. That is, the character recognition engine identifies a timing at which a score is changed.

Note that, in a case where an occurrence time of a goal scene detected by using the external data analysis engine in a scene detection phase is different from an occurrence time of the goal scene detected by using the character recognition engine in a scene extraction phase, STATS information acquired from outside and stored in the storage unit 58 of the information processing apparatus 1 may be corrected.

After the occurrence time of the goal scene is identified by the character recognition engine, a range of fixed seconds before and after the scene occurrence time is decided by using the fixed-seconds clipping engine.

In the detail description, detailed information is extracted by using the external data analysis engine. With this arrangement, additional information about the extracted scene is acquired.

### 6-3. Third Example

A third example of automatic parameter adjustment is illustrated in FIG. 19. Note that the processing executed by the control unit 10 in the third example is similar to the processing illustrated in FIG. 17, and thus description thereof will be omitted.

The third example is an example in a case where the sport type of an object to be imaged is “Tennis”.

Similarly to American football and soccer, in the scene detection, STATS information is analyzed by using the external data analysis engine, and a scene occurrence time is identified. In the present example, a scene to be extracted is a scene of “Break Point”, “Match Point”, or the like, for example.

In the scene extraction, different analysis engines 11 and parameters are automatically selected for each type of the scenes detected in the scene detection.

In a case where the scene type is “Break Point”, the character recognition engine for extracting text information of Score 40 or A (advantage) from a subtitle superimposed on a captured image is selected as the analysis engine 11 for detection of an in-point, and a parameter suitable for analysis by the character recognition engine is automatically selected and assigned. Furthermore, for detection of an out-point, the camera switching analysis engine that detects a timing at which a scene is switched is selected, and a parameter suitable for analysis of the camera switching analysis engine is automatically selected and assigned.

In a case where the scene type is “Match Point”, the character recognition engine for extracting score information from the subtitle superimposed on the captured image is selected as the analysis engine 11 for detection of the in-point, and a parameter suitable for analysis by the character recognition engine is automatically selected and assigned. Furthermore, for detection of the out-point, the excitement section analysis engine for detecting a time point at which excitement in a game venue ends is selected, and a parameter suitable for analysis of the excitement section analysis engine is automatically selected and assigned.

In the detail description, detailed information is extracted by using the external data analysis engine. With this arrangement, additional information about the extracted scene is acquired.

### 6-4. Fourth Example

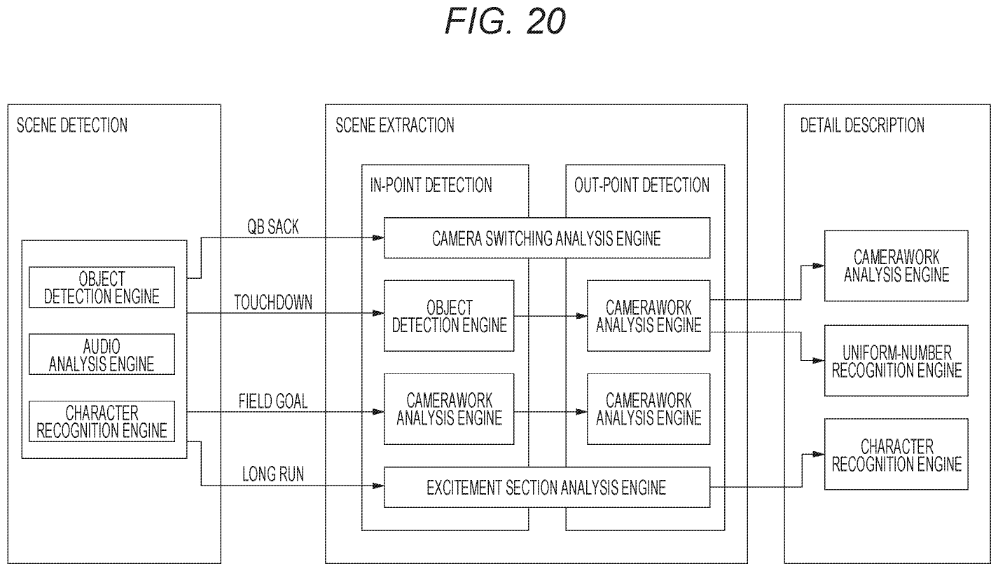

In each of the first to third examples, an example of detecting, in scene detection, a specific scene by using STATS information serving as external data has been described. In a fourth example, a specific scene is detected by analyzing not external data but received moving image data (refer to FIG. 20). Note that, in the present example, analysis is performed on moving image data obtained by capturing an image of an American football game.

In the scene detection, first, the object detection engine, the audio analysis engine, and the character recognition engine are selected as the analysis engines 11 to be applied to uploaded moving image data. Similarly to the first example, a scene to be extracted is a scene of “QB Sack”, “Touchdown”, “Field Goal”, “Long Run” or the like, for example.

Specifically, an object appearing in the image is analyzed to detect a touchdown scene by detecting that the ball has landed in an end zone. However, because there is also a possibility of erroneous sensing, a degree of certainty of the detected scene being a touchdown scene is improved by the audio analysis engine, which analyzes excitement in the venue and words of a commentator, the character recognition engine, which analyzes a decorative character or the like superimposed on the image, or the like.

That is, a detection target scene is detected by causing various analysis engines 11 to cooperate.

In the scene extraction, in in-point detection, the camera switching analysis engine, the object detection engine, the camerawork analysis engine, the excitement section analysis engine, or the like is appropriately selected according to the scene type, and an optimal parameter is automatically selected and assigned according to the selected analysis engine 11 or scene type.

Furthermore, in out-point detection, the camera switching analysis engine, the camerawork analysis engine, the excitement section analysis engine, or the like is appropriately selected, and an optimal parameter is automatically selected and assigned according to the selected analysis engine 11 or scene type.

Selection of these analysis engines 11 in the scene extraction is similar to the selection in the first example, and thus detailed description thereof is omitted.

In the detail description, unlike each example described above, the analysis engine 11 different for each detection target scene is selected.

For example, in a case where the scene type is “QB Sack” or “Field Goal”, the analysis engine 11 may not be selected. Thus, determination that the analysis engine 11 is not used is one option.

Furthermore, in a case where the scene type is “Touchdown”, the camerawork analysis engine 11 is selected to detect a scene of an upper body or close-up of a player, the uniform-number recognition engine is selected to identify a player who has succeeded in a touchdown or a player who has made an important pass, and the like, and a parameter suitable for each is automatically assigned.

In a case where the scene type is “Long Run”, in order to detect how far the long-run play is, that is, in order to detect how many yards the player has picked up, the character recognition engine, which detects a yard mark superimposed on a field image of the game, is selected, and a parameter is automatically assigned.

Note that, in a case where STATS information serving as external data can be acquired, local STATS information acquired and stored in the storage unit 58 may be compared with detailed information extracted in the detail description. Furthermore, in this case, in a case the detailed information is different, processing of correcting the local STATS information may be performed by using the detailed information extracted in the detail description.

Thus, an analysis engine 11 selected and a parameter assigned may be different or the same depending on the scene type, and a plurality of analysis engines 11 may be selected, or no analysis engine 11 may be utilized.

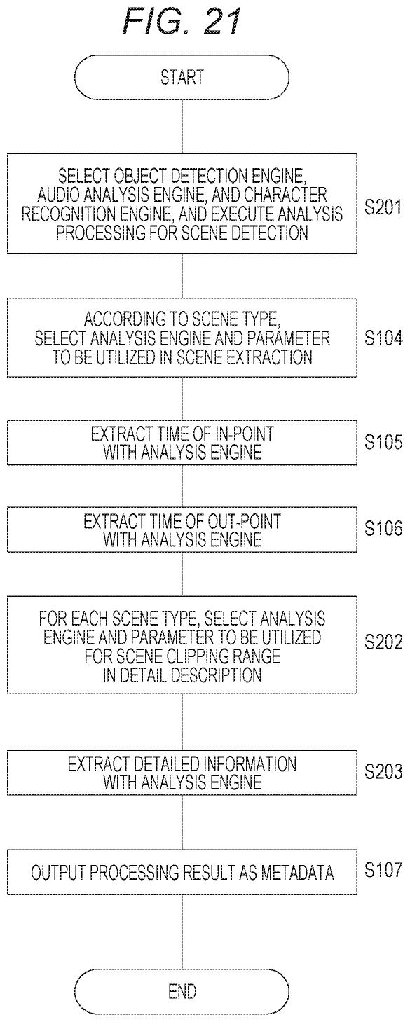

FIG. 21 illustrates a flow of processing executed by the control unit 10 in the fourth example. Note that processing similar to the processing illustrated in FIG. 17 is denoted by the same reference signs, and description thereof is omitted as appropriate.

In Step S201, the control unit 10 selects analysis engines 11 and parameters to be used in the scene detection, and performs analysis processing. Specifically, the object detection engine, the audio analysis engine, and the character recognition engine are selected, and the analysis processing is executed according to assigned parameters.

Note that, in a case where the detection target scene cannot be detected by this analysis processing, the series of processing illustrated in FIG. 21 may be ended.

In a case where one or a plurality of detection target scenes can be detected, the control unit 10 executes processing in Steps S104, S105, S106, S202, S203, and S107 subsequent for each detected scene.

Specifically, in Step S104, the control unit 10 selects an analysis engine 11 and parameter to be used in the scene extraction according to the scene type or the like.

Moreover, the control unit 10 extracts a time of an in-point corresponding to the scene type in Step S105, and similarly extracts a time of an out-point in Step S106.

Next, in Step S202, for each scene type, for the scene clipping range, the control unit 10 selects an analysis engine 11 to be utilized in the detail description and assigns a parameter.

Subsequently, in Step S203, the control unit 10 extracts detailed information with the analysis engine.

Finally, in Step S107, the control unit 10 outputs information extracted in each phase as metadata.

A mode of the processing as illustrated in FIG. 21 is, for example, an example of a case where complete moving image data of an image captured from a start of a game to an end of the game is uploaded, or the like. That is, after all the occurrence times of the detection target scene are detected from the respective scenes recorded in the moving image data in Step S201, the processing in and after Step S104 is executed on the detected scenes, and thus the processing is not looped.

In order to detect the detection target scene and output the metadata in parallel with progress of the game, a flow of the processing illustrated in FIG. 21 may be modified to a flow as illustrated in FIG. 17 to have a program configuration including a loop so as to repeatedly execute the processing of each Step. Specifically, it is only required to execute the analysis processing in Step S201 on latest moving image data uploaded as needed, and, in a case where it is determined that the detection target scene is included, execute the processing in and after Step S104, or, in a case where the detection target scene is not included, wait until next moving image data being uploaded, and execute the processing in Step S201 again.

### 7. Functional Block for Performing Real-Time Analysis Processing

### 7-1. Highlight-Video Generation

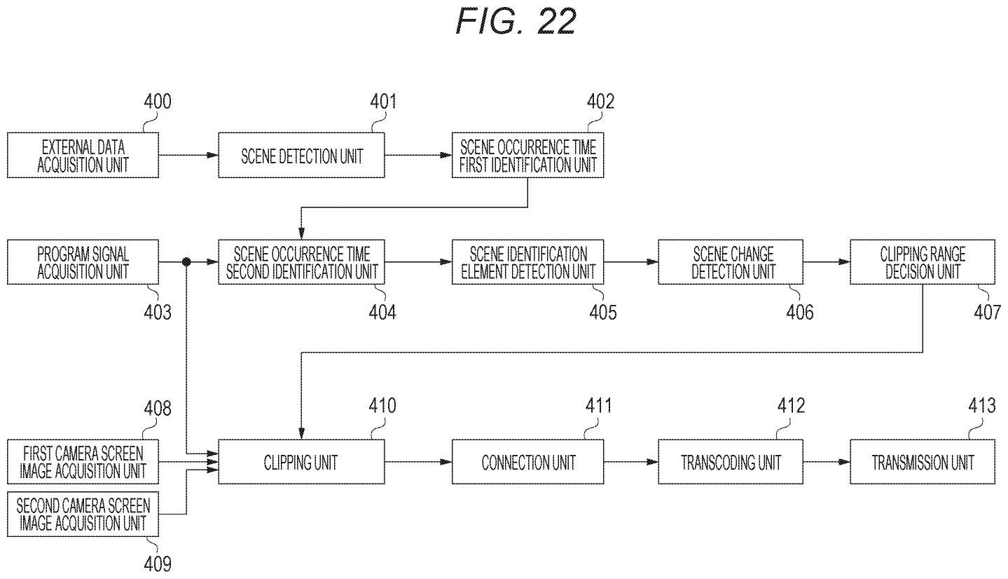

FIG. 22 illustrates a configuration example of functional blocks constructed in the control unit 10 to generate a highlight video while receiving a screen image of a game in real time.

For example, constructed in the control unit 10 are functions such as an external data acquisition unit 400, a scene detection unit 401, a scene occurrence time first identification unit 402, a program (PGM) signal acquisition unit 403, a scene occurrence time second identification unit 404, a scene identification element detection unit 405, a scene change detection unit 406, a clipping range decision unit 407, a first camera screen image acquisition unit 408, a second camera screen image acquisition unit 409, a clipping unit 410, a connection unit 411, a transcoding unit 412, and a transmission unit 413

The external data acquisition unit 400 performs processing of acquiring the above-described STATS information as external data.

The scene detection unit 401 receives the STATS information from the external data acquisition unit 400 and detects a detection target scene.

The scene occurrence time first identification unit 402 identifies the scene occurrence time on the basis of the STATS information.

That is, the external data acquisition unit 400, the scene detection unit 401, and the scene occurrence time first identification unit 402 are functions for scene detection utilizing an analysis engine 11 and parameter.

The program signal acquisition unit 403 acquires a PGM output signal, which is a video signal audio signal on which an effect, a subtitle, or the like is superimposed. The PGM output signal is, for example, a signal for a screen image to be distributed to each home.

The scene occurrence time second identification unit 404 identifies the occurrence time of the detection target scene by performing optical character recognition (OCR) processing on an image based on the PGM output signal. This processing can be efficiently performed by narrowing a section to be processed on the basis of the scene occurrence time identified from the STATS information serving as the external data. Furthermore, this processing is also processing of checking whether or not the scene occurrence time according to the STATS information is correct.

The scene identification element detection unit 405 detects a decorative character or the like superimposed and displayed on the image by performing OCR processing on the image based on a PGR output signal. This processing is processing of confirming that the detected scene is definitely the detection target scene.

The scene occurrence time second identification unit 404 and the scene identification element detection unit 405 are utilized in the scene detection phase.

The scene change detection unit 406 detects a scene of a scene change by analyzing camerawork.

The clipping range decision unit 407 identifies an in-point and out-point for deciding a scene clipping range.

The scene change detection unit 406 and the clipping range decision unit 407 are utilized in the scene extraction.

The first camera screen image acquisition unit 408 and the second camera screen image acquisition unit 409 acquire a screen image captured by a camera shooting the game. The first camera to be acquired by the first camera screen image acquisition unit 408 and a second camera to be acquired by the second camera screen image acquisition unit 409 are different imaging apparatuses.

Note that in a case where three or more cameras are set in the game venue, camera screen image acquisition units of the same number as the number of the cameras may be provided.

The clipping unit 410 performs clipping processing of screen images corresponding to the scene clipping range from the screen image captured by the first camera and the screen image captured by the second camera according to the clipping range.

The connection unit 411 connects clipped screen images into one piece of moving image data (highlight video data).

The transmission unit transmits the generated highlight video data to an external information processing apparatus.

In the example illustrated in FIG. 22, the external data analysis engine, the character recognition engine, or the like is selected as the analysis engine 11 used in the scene detection. Furthermore, the camerawork analysis engine or the like is selected as the analysis engine 11 used in the scene extraction. The detail description may not be performed, or may be executed similarly to an above-described example.

Note that, by using the functional configuration illustrated in FIG. 22, not only a highlight video but also the above-described short-version video or the like can be generated.

### 7-2. Real-Time Distribution

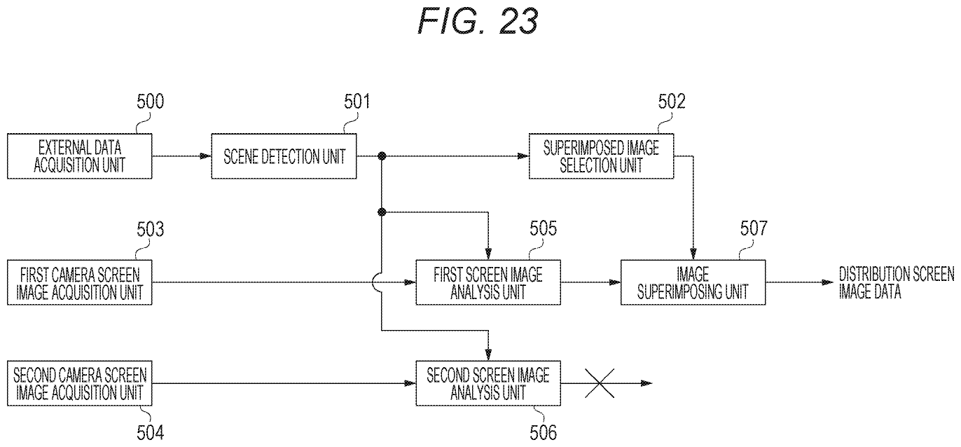

FIG. 23 illustrates a configuration example of functional blocks constructed in the control unit 10 in a case where distribution screen image data is generated, superimposing computer graphics (CG), an effect image, a subtitle, or the like in substantially real time while capturing a screen image of the game.

For example, constructed in the control unit 10 are functions such as an external data acquisition unit 500, a scene detection unit 501, a superimposed image selection unit 502, a first camera screen image acquisition unit 503, a second camera screen image acquisition unit 504, a first screen image analysis unit 505, a second screen image analysis unit 506, an image superimposing unit 507, and the like.

The external data acquisition unit 500 performs processing of acquiring the above-described STATS information as external data.

The scene detection unit 501 receives the STATS information from the external data acquisition unit 500 and detects a detection target scene. Specifically, occurrence time of the detection target scene is identified by using an analysis engine 11.

The superimposed image selection unit 502 selects a superimposed image corresponding to the detected scene. For example, if the detected scene is a scene of “Touchdown”, a CG image or 3D image of a decorative character string “TOUCHDOWN” is selected.

The first camera screen image acquisition unit 503 acquires moving image data (captured image data) captured by the first camera shooting the game.

Similarly, the second camera screen image acquisition unit 504 acquires moving image data captured by the second camera. Similarly to the above example, three or more camera screen image acquisition units may be provided, or one camera screen image acquisition unit may be able to acquire moving image data captured by a plurality of cameras.

The first screen image analysis unit 505 performs analysis processing of the moving image data captured by the first camera, and determines whether or not a detection target scene detected from the STATS information can be detected from the moving image data. Furthermore, the second screen image analysis unit 506 performs analysis processing of the moving image data captured by the second camera, and determines whether or not the detection target scene can be detected from the moving image data.

The processing by the first screen image analysis unit 505 and the second screen image analysis unit 506 is also processing of selecting moving image data appropriate for conveying the detection target scene from the moving image data captured by either the first camera or the second camera. That is, if it is determined that the screen image captured by the first camera is more appropriate for conveying a viewer/listener that a “Touchdown” scene has occurred, the moving image data captured by the first camera is selected as the moving image data to be distributed (broadcast).

Note that it is not always necessary to select moving image data captured by one camera for one detection target scene. For example, for a scene of 20 seconds, the moving image data captured by the first camera may be selected for a first five seconds, the moving image data captured by the second camera may be selected for a next 10 seconds, and the moving image data captured by the first camera may be selected again for a last five seconds.

With this arrangement, distribution of the game is performed by utilizing most suitable moving image data among the plurality of cameras.

Note that the state illustrated in FIG. 23 indicates a state in which the moving image data captured by the first camera is selected.

Note that, in a case where it is determined that the moving image data captured by the first camera and the moving image data captured by the second camera are appropriate for conveying the detection target scene, the moving image data captured by the second camera may be distributed with a delay after the moving image data captured by the first camera is distributed, or a display region may be divided so that the screen images captured by the plurality of cameras are displayed on one screen, and the screen images may be distributed.

The image superimposing unit 507 performs processing of superimposing the superimposed image selected by the superimposed image selection unit 502 on the moving image data selected by a screen image analysis unit. In this processing, for example, processing of adjusting a size of the superimposed image, processing of deciding a position at which the image is to be superimposed, and the like are performed.

Furthermore, it is conceivable that a time point from which the superimposed image is superimposed on a time axis is based on a processing result of the scene extraction (for example, time information of an in-point and out-point). Note that, at this time, if the superimposed image is superimposed from the in-point, there is a possibility that excitement is reduced. For example, if the superimposed image for a touchdown is superimposed from the in-point, an image of “TOUCHDOWN” is displayed before the occurrence time of the touchdown, and the play result is known in advance. In such a case, it is desirable to decide a section during which the image is to be superimposed, on the basis of a processing result of the scene detection (for example, the scene occurrence time) and a processing result of the scene extraction (for example, time information of the out-point).

The moving image data on which the superimposed image is superimposed is output as distribution screen image data.

Note that, during a period of time other than a time when a detection target scene occurs, there may be no appropriate superimposed image, and simply the screen image captured by the first camera or the screen image captured by the second camera may be output as the distribution screen image data.

### 8. Others

The scene occurrence time identified in the scene detection and the time information decided as the in-point and out-point of the scene clipping range in the above-described example may be a time elapsed from a start of the game or actual time.

Furthermore, the above-described various functions provided by the information processing apparatus 1 may be utilized when the user edits a video utilizing application software. For example, when operation utilizing analysis processing utilizing an AI engine (analysis engine 11 described above) is performed at a time of video editing, moving image data is uploaded, on the basis of processing of the application software, to an analysis system (information processing apparatus 1 described above) constructed on a cloud. The analysis system transmits moving image data, metadata, and the like of an analysis result to a terminal (a mobile terminal or the like) used by the user. With this arrangement, the user can utilize various analysis functions and edit functions on the cloud, by which work efficiency is improved.

Note that, at this time, the analysis system constructed on the cloud may be able to utilize not only the various analysis engines 11 managed inside the analysis system, but also an analysis engine 11 outside the analysis system (for example, an analysis engine 11 of which function is provided by an information processing apparatus of another company). With this arrangement, it is possible to provide a wide variety of functions of the analysis engine 11, and thus, it is possible to appropriately respond to wide-ranging requests from users, and to provide an analysis result with high user satisfaction. Furthermore, because the analysis system does not need to prepare all the analysis engines 11, the analysis system can be constructed compactly, by which a time required for the construction can be shortened, and a development cost can be kept low.

### 9. Conclusion

The information processing apparatus 1 described above includes the control unit 10 that performs first control processing (processing executed in scene detection) and second control processing (processing executed in scene extraction). The first control processing is processing of deciding an analysis engine 11 for scene detection from among a plurality of analysis engines 11 on the basis of scene detection information for scene detection (parameter assigned for scene detection processing) with respect to an input video (moving image data from a camera installed in a game venue).

Furthermore, second processing is processing of deciding an analysis engine 11 for obtaining second result information related to the scene (for example, time information of an in-point and out-point) from among a plurality of analysis engines, on the basis of scene-related information (parameter assigned for scene extraction) regarding a scene obtained as first result information (for example, information of a scene occurrence time) by the analysis engine 11 decided in the first control processing.

The input video is assumed to be, for example, content produced on the basis of images of a certain sport captured by one or a plurality of cameras, or the like. Furthermore, there is assumed a system having a plurality of analysis engines 11 for analyzing such a video. In such a system, an information processing apparatus including a function as a control unit 10 decides, in first control processing, one or a plurality of analysis engines 11 for detecting a predetermined scene as first result information in the video, and decides, in second control processing, one or a plurality of analysis engines 11 for identifying second result information related to the scene.

With the information processing apparatus 1 according to such an embodiment, an analysis engine 11 that performs analysis as scene detection or scene extraction is appropriately selected according to intention of the user, a sport type such as sports, a state of a video shooting site, and the like. With this arrangement, it is possible to achieve improvement of analysis accuracy, and to improve performance of the system that achieves provision of appropriate metadata, image data, and the like to the user. Note that, here, the object to be imaged is a sport, but the object to be imaged is not limited to a sport. For example, the object to be imaged may be a concert, a speech for recording, a meal party, another daily life, or a screen image captured by a surveillance camera. In this sense, a sport type can also be referred to as a moving image type.

In the information processing apparatus 1, the second result information may include time information related to the scene obtained as the first result information.

That is, in the second control processing, an analysis engine 11 for obtaining the second result information including at least time information regarding the scene is decided.

Regarding the time information related to the scene detected in the scene detection, for example, a timecode or the like specifying a section of the scene can be obtained as the second result information, by which information extraction that fulfills a purpose of the scene extraction, that is, scene extraction is achieved.

In the information processing apparatus 1, the second result information may include scene start information related to a start of the scene obtained as the first result information and scene end information related to an end of the scene obtained as the first result information, and, in the second control processing (processing executed in scene extraction), an analysis engine 11 for identifying the scene start information and an analysis engine 11 for identifying the scene end information may be decided.

That is, in the second control processing, analysis engines 11 for obtaining the second result information including scene start information and scene end information are decided as the second result information, in which analysis engines 11 corresponding to each of the scene start information and the scene end information are decided.

For example, as described with reference to FIGS. 6, 16, and the like, in order to obtain the in-point serving as the scene start information and the out-point serving as the scene end information in the scene extraction, the analysis engines 11 are decided for each.

For appropriate detection of the in-point and appropriate detection of the out-point, appropriate conditions for each detection are assumed. Therefore, detection of the in-point/out-point with different analysis engines 11 is useful for improving accuracy.

Of course, in some cases, it is appropriate to detect the in-point/out-point with the same analysis engine 11, but in any case, by identifying an analysis engine 11 for each of the scene start information and the scene end information, facilitation of detection processing and improvement of detection accuracy can be achieved.

In the information processing apparatus 1, the scene-related information may include scene-type information, and, in the second control processing (processing executed in scene extraction), an analysis engine 11 for obtaining second result information may be decided on the basis of the scene-type information.

That is, in the second control processing, an analysis engine 11 for obtaining the second result information is decided, in which a corresponding analysis engine 11 is decided according to a type of a target scene.

For example, as described in FIG. 16 and the like, the control unit 10 decides an analysis engine 11 for scene extraction according to a scene type, for example, a scene of “Touchdown”, a scene of “Field Goal”, or the like. For the analysis for the scene extraction, an appropriate condition for obtaining the second result information is assumed according to the scene type. Therefore, appropriate accuracy improvement is achieved by performing scene extraction with an analysis engine 11 corresponding to a sport type.

In the information processing apparatus 1, the second result information may include scene start information related to a start of the scene obtained as the first result information and scene end information related to an end of the scene obtained as the first result information, and, in the second control processing (processing executed in scene extraction), an analysis engine 11 for identifying the scene start information and an analysis engine 11 for identifying the scene end information may be decided according to a type of the scene obtained as the first result information.

That is, in the second control processing, analysis engines 11 for obtaining the second result information including scene start information and scene end information are decided as the second result information, in which an analysis engine 11 for obtaining the scene start information and an analysis engine 11 for obtaining the scene end information are decided according to a scene type

For example, as described with reference to FIG. 16 and the like, in order to obtain the in-point serving as the scene start information and the out-point serving as the scene end information, the analysis engines 11 are decided for each, and it is set according to a scene type.

Appropriate detection of the in-point and appropriate detection condition of the out-point are also different depending on a scene type, for that, accuracy improvement becomes able to be contributed by deciding the analysis engines 11 that detect the in-point and the out-point separately, according to the scene type.

In the information processing apparatus 1, the second result information may include time information related to the scene obtained as the first result information, and the control unit 10 may perform third control processing (processing executed in detail description) of deciding, from among a plurality of analysis engines 11, an analysis engine 11 for obtaining third result information obtained by analyzing a section identified in a video with the time information.

In a case where a section in the video is identified for a certain scene as the second result information, an analysis engine 11 for performing detailed analysis of the section is decided.

The control unit 10 decides an analysis engine 11 also to analyze the detail description.

In particular, by analyzing the detail description for a section extracted in the scene extraction, for example, a section from the in-point to the out-point, detailed information can be extracted without unnecessarily increasing processing load.

In the information processing apparatus 1, in the third control processing (processing executed in detail description), an analysis engine 11 for obtaining third result information may be decided on the basis of scene-type information.

That is, in the third control processing, an analysis engine 11 for obtaining the third result information is decided, in which a corresponding analysis engine 11 is decided according to a type of a target scene.

By an analysis engine 11 appropriate for the detail description being decided according to the type of sport or scene, improvement of accuracy and facilitation of the analysis processing can be achieved.

In the information processing apparatus 1, the scene-related information may be managed in association with the scene detection information (parameter assigned for scene detection processing), and the scene-related information (parameter assigned for scene extraction processing) may be set corresponding to a setting of the scene detection information.

The management is performed such that the scene-related information is identified in response to identification of the scene detection information for scene detection.

The control unit 10 identifies a scene detection parameter (scene detection information) according to, for example, a sport type or a scene type, and makes a scene extraction parameter (scene-related information) also identified according to the parameter.

In this way, appropriate parameters for the scene detection and the scene extraction are set according to the sport type and the scene type.

In the information processing apparatus 1, the control unit 10 may set the scene detection information corresponding to input of a scene type.

For example, the scene detection information is set according to a scene type input according to a user operation, automatic determination, or the like.

The control unit 10 sets a scene detection parameter (scene detection information) by the scene type being input in response to a user operation, automatic determination, or the like. With this arrangement, it is possible to decide an appropriate analysis engine 11 according to a scene to be detected.

In the information processing apparatus 1, the control unit 10 may set the scene detection information (parameter assigned for scene detection processing) corresponding to input of a sport type.

For example, the scene detection information is set according to a sport type (for example, a sport type of sports, or the like) input according to a user operation, automatic determination, or the like.

The control unit 10 sets a scene detection parameter (scene detection information) by the sport type being input in response to a user operation, automatic determination, or the like. With this arrangement, it is possible to decide an appropriate analysis engine 11 according to a scene to be detected.

In the information processing apparatus 1, the control unit 10 may generate metadata based on the first result information (for example, information of a scene occurrence time) and the second result information (for example, time information of an in-point and out-point), and may perform processing of linking the generated metadata to the input video.

For example, information such as detected scene information and time information thereof are generated as metadata and used as information related to the input video.

The control unit 10 generates metadata on the basis of an analysis result of the scene detection (first result information) and an analysis result of the scene extraction (second result information), links the metadata to the input video, and outputs the metadata as an analysis result (refer to FIG. 16 and the like). With this arrangement, the metadata linked to the input video serving as an analysis target can be transmitted to a user side, and an appropriate analysis service can be provided to the user.

In the information processing apparatus 1, the control unit 10 may generate metadata based on the first result information (for example, information of a scene occurrence time), the second result information (for example, time information of an in-point and out-point), and the third result information (for example, information regarding a player who has been active in a corresponding scene), and may perform processing of linking the generated metadata to the input video.

For example, information such as detected scene information, time information thereof, and further detailed information is generated as metadata and used as information related to the input video.

The control unit 10 generates metadata on the basis of an analysis result of the scene detection (first result information), an analysis result of the scene extraction (second result information), and analysis result of the detail description, links the metadata to the input video, and outputs the metadata as an analysis result (refer to Fig.). With this arrangement, the metadata linked to the input video serving as the analysis target and including more detailed information can be transmitted to the user side, and content of the analysis service provided to the user can be enriched.

In the information processing apparatus 1, on a scene as a detection target with respect to the input video, the control unit 10 may compare time information obtained as the first result information (for example, information of a scene occurrence time) and time information provided as external data (for example, time information in STATS information), and, in a case of discrepancy, may perform processing of overwriting the time information provided as the external data with the time information obtained as the first result information.

For example, with respect to a timecode or the like of the scene, external data provided like STATS information is rewritten according to an analysis result.

With this arrangement, the STATS information can be corrected according to the analysis result, and data or the like for edit based on information consistent with the analysis result can be provided.

In the information processing apparatus 1, on a scene as a detection target with respect to an input video, the control unit 10 may compare accompanying information obtained as third result information (extracted detailed information) obtained by an analysis engine 11 decided in the third control processing and accompanying information provided as external data, and, in a case of discrepancy, may perform processing of overwriting the accompanying information provided as the external data with the accompanying information obtained as the third result information.

For example, with respect to accompanying information of the scene, external data provided like STATS information is rewritten according to an analysis result.

With this arrangement, accompanying information provided in the STATS information can be corrected according to the analysis result, and data or the like for edit based on information consistent with the analysis result can be provided.

In the information processing apparatus 1, the control unit 10 may select or generate image information (superimposed image) corresponding to the scene obtained as the first result information, and may perform processing of combining the image information with the input video.

For example, an image corresponding to the scene (for example, an image of a decorative character string “TOUCHDOWN”) is generated, or a suitable image is selected from among prepared images. Such an image is combined with the input video. With this arrangement, an image in which an appropriate CG image or the like is combined with a section of a scene or the like can be provided to the user side, and cloud service content can be expanded.

Of course, instead of providing the image, information or the like of a section in the video, the section being to be combined with a CG image, may be provided so that combination processing can be easily performed on the user side.

In the information processing apparatus 1, the second result information may include time information related to the scene obtained as the first result information, and the control unit 10 may perform processing of superimposing the image information on the input video on the basis of time information obtained from the first result information or from the second result information.

For example, in a case where an image corresponding to the scene is combined, a section to be combined is set according to time information obtained from an analysis result.

The control unit 10 can superimpose a composite image on an appropriate section in the video on the basis of time information (time information of an in-point and out-point) obtained in the scene extraction.

In this case, for example, in a case where an image of “Touchdown” is combined in a touchdown scene, or the like, for example, if the image is combined not in a section from an in-point to an out-point but in a section from a timecode at a scene occurrence time point to the out-point (or may be up to a time point slightly before the out-point), it is possible to generate a video in which the image of “Touchdown” is displayed from a moment of the touchdown. That is, by effectively using time information determined in the scene detection or scene extraction, automatic image combination can be performed in an appropriate section.

An information processing method executed by an information processing apparatus 1 includes first control processing of deciding an analysis engine 11 for scene detection from among a plurality of analysis engines 11 on the basis of scene detection information for scene detection with respect to an input video, and second control processing of deciding an analysis engine 11 for obtaining second result information related to the scene from among a plurality of analysis engines 11, on the basis of scene-related information regarding a scene obtained as first result information by the analysis engine 11 decided in the first control processing.

Furthermore, a program caused to be executed by an information processing apparatus 1 includes first control processing of deciding an analysis engine 11 for scene detection from among a plurality of analysis engines 11 on the basis of scene detection information for scene detection with respect to an input video, and second control processing of deciding an analysis engine 11 for obtaining second result information related to the scene from among a plurality of analysis engines 11, on the basis of scene-related information regarding a scene obtained as first result information by the analysis engine 11 decided in the first control processing.

According to such an information processing method and program, it is possible to construct the above-described various functional configurations and to achieve the above-described functions and effects.

Note that the effects described herein are only examples, and the effects of the present technology are not limited to these effects. Additional effects may also be obtained.

Furthermore, the above-described examples can be combined in any manner unless the combination is impossible.

### 10. Present Technology

(1)

An information processing apparatus including a control unit that performs

first control processing of deciding an analysis engine for scene detection from among a plurality of analysis engines on the basis of scene detection information for scene detection with respect to an input video, and

second control processing of deciding an analysis engine for obtaining second result information related to the scene from among a plurality of analysis engines, on the basis of scene-related information regarding a scene obtained as first result information by the analysis engine decided in the first control processing.

(2)

The information processing apparatus according to (1), in which the second result information includes time information related to the scene obtained as the first result information.

(3)

The information processing apparatus according to (1) or (2),

in which the second result information includes scene start information related to a start of the scene obtained as the first result information and scene end information related to an end of the scene obtained as the first result information, and

in the second control processing,

an analysis engine for identifying the scene start information and

an analysis engine for identifying the scene end information are decided.

(4)

The information processing apparatus according to any one of (1) to (3),

in which the scene-related information includes scene-type information, and

in the second control processing, an analysis engine for obtaining second result information is decided on the basis of the scene-type information.

(5)

The information processing apparatus according to any one of (1) to (4),

in which the second result information includes scene start information related to a start of the scene obtained as the first result information and scene end information related to an end of the scene obtained as the first result information, and

in the second control processing,

an analysis engine for identifying the scene start information and an analysis engine for identifying the scene end information are decided according to a type of the scene obtained as the first result information.

(6)

The information processing apparatus according to any one of (1) to (5),

in which the second result information includes time information related to the scene obtained as the first result information, and

the control unit performs third control processing of deciding, from among a plurality of analysis engines, an analysis engine for obtaining third result information obtained by analyzing a section identified in a video with the time information.

(7)

The information processing apparatus according to (6), the information processing apparatus deciding, in the third control processing, on the basis of scene-type information, an analysis engine for obtaining third result information.

(8)

The information processing apparatus according to any one of (1) to (7),

in which the scene-related information is managed in association with the scene detection information, and the scene-related information is set corresponding to a setting of the scene detection information.

(9)

The information processing apparatus according to any one of (1) to (8),

in which the control unit sets the scene detection information corresponding to input of a scene type.

(10)

The information processing apparatus according to any one of (1) to (9),

in which the control unit sets the scene detection information corresponding to input of a sport type.

(11)

The information processing apparatus according to any one of (1) to (10),

in which the control unit

generates metadata based on the first result information and the second result information, and

performs processing of linking the generated metadata to the input video.

(12)

The information processing apparatus according to (6) or (7),

in which the control unit

generates metadata based on

the first result information,

the second result information, and

the third result information, and

performs processing of linking the generated metadata to the input video.

(13)

The information processing apparatus according to any one of (1) to (12),

in which, on a scene as a detection target with respect to the input video,

the control unit compares

time information obtained as the first result information and

time information provided as external data, and,

in a case of discrepancy, performs processing of overwriting the time information provided as the external data with the time information obtained as the first result information.

(14)

The information processing apparatus according to (6),

in which, on a scene as a detection target with respect to an input video,

the control unit compares

accompanying information obtained as third result information obtained by an analysis engine decided in the third control processing and

accompanying information provided as external data, and,

in a case of discrepancy, performs processing of overwriting the accompanying information provided as the external data with the accompanying information obtained as the third result information.

(15)

The information processing apparatus according to any one of (1) to (14),

in which the control unit

selects or generates image information corresponding to the scene obtained as the first result information, and

performs processing of combining the image information with the input video.

(16)

The information processing apparatus according to (15),

in which the second result information includes time information related to the scene obtained as the first result information, and

the control unit performs processing of superimposing the image information on the input video on the basis of time information obtained from the first result information or from the second result information.

(17)

An information processing method in which an information processing apparatus performs

first control processing of deciding an analysis engine for scene detection from among a plurality of analysis engines on the basis of scene detection information for scene detection with respect to an input video, and

second control processing of deciding an analysis engine for obtaining second result information related to the scene from among a plurality of analysis engines, on the basis of scene-related information regarding a scene obtained as first result information by the analysis engine decided in the first control processing.

(18)

A program causing an information processing apparatus to execute

first control processing of deciding an analysis engine for scene detection from among a plurality of analysis engines on the basis of scene detection information for scene detection with respect to an input video, and

second control processing of deciding an analysis engine for obtaining second result information related to the scene from among a plurality of analysis engines, on the basis of scene-related information regarding a scene obtained as first result information by the analysis engine decided in the first control processing.

Note that correspondence between terms described in the present technology and terms described in the embodiments will be described.

In response to a request from an operator or according to an automatically set purpose, processing of selecting an analysis engine 11 is performed as “first control processing” in a scene detection phase.

Furthermore, various parameters serving as “scene detection information” are assigned to the analysis engine 11 selected in the scene detection phase. That is, the scene detection information is information for detecting a specific scene.

For example, information for identifying a sport type (such as American football or soccer), information for identifying a scene to be extracted (such as touchdown or field goal), various dictionary information, and the like are part of the scene detection information.

In the scene detection phase, information regarding a detected scene, for example, information such as a scene occurrence time, is detected (extracted) as “first result information”.

That is, in the scene detection, the first control processing is performed using the scene detection information and moving image data as inputs, an analysis engine 11 is decided, analysis processing is executed, and then the first result information is output.

In the scene detection phase, processing of selecting an analysis engine 11 for identifying a range of the detected scene is performed as “second control processing”.

Furthermore, various parameters serving as “scene-related information” are assigned to the analysis engine 11 selected in the scene extraction phase.

For example, an excitement determination threshold value, a switching determination threshold value, and the like are part of the scene-related information used to identify a start (in-point) and end (out-point) of a specific scene.

In the scene extraction phase, time information regarding the in-point or out-point or the like is extracted as “second result information”.

That is, in the scene extraction, the second control processing is performed using the moving image data, the first result information, and the scene-related information as inputs, an analysis engine 11 is decided, analysis processing is executed, and then the second result information is output.

In a detail description phase, processing of selecting an analysis engine 11 for obtaining detailed information regarding an identified scene is performed as “third control processing”.

Furthermore, various parameters serving as “extracted detailed information” are assigned to the analysis engine 11 selected in the detail description phase.

For example, dictionary information by sport, scoring standards information by sport, and the like are parameters for extracting detailed information, and thus can be said to be part of the extracted detailed information.

In the detail description phase, information such as a uniform number or name of an active player, which is detailed information of the detected scene, is extracted as “third result information”.

That is, in the detail description, the third control processing is performed using the moving image data, the first result information and second result information, and the extracted detailed information as inputs, an analysis engine 11 is decided, analysis processing is executed, and then the third result information is output.

The scene detection information assigned to processing related to the scene detection and the scene-related information assigned to processing related to the scene extraction may be managed in association with each other. For example, a parameter for scene detection and a parameter used for deciding a clipping range may be linked to information of a sport type or information of a scene type so that both the parameters are associated with each other.

Note that parameters (scene detection information, scene-related information, and extracted detailed information) assigned to the analysis engines 11 in each phase include parameters specified by the operator and parameters automatically set.

Furthermore, a parameter is not always necessary in each phase, and no parameter may be necessary depending on the selected analysis engine 11.

### REFERENCE SIGNS LIST

1 Information processing apparatus
10 Control unit
11 Analysis engine

1. An information processing apparatus comprising a control unit that performs
first control processing of deciding an analysis engine for scene detection from among a plurality of analysis engines on a basis of scene detection information for scene detection with respect to an input video, and
second control processing of deciding an analysis engine for obtaining second result information related to the scene from among a plurality of analysis engines, on a basis of scene-related information regarding a scene obtained as first result information by the analysis engine decided in the first control processing.

2. The information processing apparatus according to claim 1,
wherein the second result information includes time information related to the scene obtained as the first result information.

3. The information processing apparatus according to claim 1,
wherein the second result information includes scene start information related to a start of the scene obtained as the first result information and scene end information related to an end of the scene obtained as the first result information, and
in the second control processing,
an analysis engine for identifying the scene start information and
an analysis engine for identifying the scene end information are decided.

4. The information processing apparatus according to claim 1,
wherein the scene-related information includes scene-type information, and
in the second control processing, an analysis engine for obtaining second result information is decided on a basis of the scene-type information.

5. The information processing apparatus according to claim 1,
wherein the second result information includes scene start information related to a start of the scene obtained as the first result information and scene end information related to an end of the scene obtained as the first result information, and
in the second control processing,
an analysis engine for identifying the scene start information and an analysis engine for identifying the scene end information are decided according to a type of the scene obtained as the first result information.

6. The information processing apparatus according to claim 1,
wherein the second result information includes time information related to the scene obtained as the first result information, and
the control unit performs third control processing of deciding, from among a plurality of analysis engines, an analysis engine for obtaining third result information obtained by analyzing a section identified in a video with the time information.

7. The information processing apparatus according to claim 6,
the information processing apparatus deciding, in the third control processing, on a basis of scene-type information, an analysis engine for obtaining third result information.

8. The information processing apparatus according to claim 1,
wherein the scene-related information is managed in association with the scene detection information, and
the scene-related information is set corresponding to a setting of the scene detection information.

9. The information processing apparatus according to claim 1,
wherein the control unit sets the scene detection information corresponding to input of a scene type.

10. The information processing apparatus according to claim 1,
wherein the control unit sets the scene detection information corresponding to input of a sport type.

11. The information processing apparatus according to claim 1,
wherein the control unit
generates metadata based on the first result information and the second result information, and
performs processing of linking the generated metadata to the input video.

12. The information processing apparatus according to claim 6,
wherein the control unit
generates metadata based on
the first result information,
the second result information, and
the third result information, and
performs processing of linking the generated metadata to the input video.

13. The information processing apparatus according to claim 1,
wherein, on a scene as a detection target with respect to the input video,
the control unit compares
time information obtained as the first result information and
time information provided as external data, and,
in a case of discrepancy, performs processing of overwriting the time information provided as the external data with the time information obtained as the first result information.

14. The information processing apparatus according to claim 6,
wherein, on a scene as a detection target with respect to an input video,
the control unit compares
accompanying information obtained as third result information obtained by an analysis engine decided in the third control processing and
accompanying information provided as external data, and,
in a case of discrepancy, performs processing of overwriting the accompanying information provided as the external data with the accompanying information obtained as the third result information.

15. The information processing apparatus according to claim 1,
wherein the control unit
selects or generates image information corresponding to the scene obtained as the first result information, and
performs processing of combining the image information with the input video.

16. The information processing apparatus according to claim 15,
wherein the second result information includes time information related to the scene obtained as the first result information, and
the control unit performs processing of superimposing the image information on the input video on a basis of time information obtained from the first result information or from the second result information.

17. An information processing method in which an information processing apparatus performs
first control processing of deciding an analysis engine for scene detection from among a plurality of analysis engines on a basis of scene detection information for scene detection with respect to an input video, and
second control processing of deciding an analysis engine for obtaining second result information related to the scene from among a plurality of analysis engines, on a basis of scene-related information regarding a scene obtained as first result information by the analysis engine decided in the first control processing.

18. A program causing an information processing apparatus to execute
first control processing of deciding an analysis engine for scene detection from among a plurality of analysis engines on a basis of scene detection information for scene detection with respect to an input video, and
second control processing of deciding an analysis engine for obtaining second result information related to the scene from among a plurality of analysis engines, on a basis of scene-related information regarding a scene obtained as first result information by the analysis engine decided in the first control processing.
